(19) United States
(12) Patent Application Publication
(10) Pub. No.: US 2024/0391241 A1
(43) Pub. Date: Nov. 28, 2024

(54) OBSERVING APPARATUS, PRINTING APPARATUS, AND OBSERVING METHOD

(71) Applicant: BROTHER KOGYO KABUSHIKI KAISHA, Nagoya (JP)

(72) Inventors: RYUJI KATO, Kiyosu (JP); MIKIO OGAWA, Nagoya (JP); HIROYUKI TANAKA, Inazawa (JP)

(21) Appl. No.: 18/673,582

(22) Filed: May 24, 2024

(30) Foreign Application Priority Data
May 24, 2023 (JP) 2023-085370

(51) Int. Cl. B41J 2/165; B41J 29/393

(52) U.S. Cl. CPC B41J 2/16544; B41J 2/16511; B41J 29/393; B41J 2029/3935

(57) ABSTRACT

There is provided an observing apparatus including: a first member having a first surface; a wiper configured to move relative to the first member and wipe up a liquid adhered to the first surface; and a camera configured to pick up an image of a process of wiping up the liquid adhered to the first surface with the wiper from a beginning of the wiping up of the liquid to an end of the wiping up of the liquid.

### REFERENCE TO RELATED APPLICATIONS

This application claims priority from Japanese Patent Application No. 2023-085370 filed on May 24, 2023. The entire content of the priority application is incorporated herein by reference.

### BACKGROUND ART

A printer based on the ink-jet system is an example of a printing apparatus configured to eject an ink from nozzles of a head. The printer performs various maintenance processes in order to maintain a satisfactory ejection state of the ink ejected from the nozzles. For example, a printer is known, which performs a wiping process for wiping up a foreign matter such as the ink or the like adhered to the vicinity of nozzles with a wiper.

### SUMMARY

If the head after the wiping process is observed, whether or not the ink has been wiped up can be known. However, in this method, details of the situation of the ink during the wiping cannot be known.

The present disclosure has been made taking the foregoing circumstances into consideration, an object of the present disclosure is to provide means that makes it possible to know details of situations (aspects) of a liquid during wiping.

According to a first aspect of the present disclosure, there is provided an observing apparatus including:
a first member having a first surface;
a wiper configured to move relative to the first member and wipe up a liquid adhered to the first surface; and
a camera configured to pick up an image of a process of wiping up the liquid adhered to the first surface with the wiper from a beginning of the wiping up of the liquid to an end of the wiping up of the liquid.

According to a second aspect of the present disclosure, there is provided a printing apparatus including:
a head having a first surface and a nozzle configured to eject a liquid;
a wiper configured to move relative to the head and wipe up the liquid adhered to the first surface; and
a camera configured to pick up an image of a process of wiping up the liquid adhered to the first surface with the wiper from a beginning of the wiping up of the liquid to an end of the wiping up of the liquid.

According to a third aspect of the present disclosure, there is provided an observing method using a first member having a first surface, a wiper, and a camera, the observing method including:
moving the wiper relative to the first member so as to wipe up the liquid adhered to the first surface with the wiper; and
picking up an image of a process of wiping up the liquid adhered to the first surface with the wiper from a beginning of the wiping up of the liquid to an end of the wiping up of the liquid by the camera.

According to the observing apparatus, the printing apparatus, and the observing method described above, the image of the process of wiping up the liquid adhered to the first surface with the wiper is picked up from the beginning to the end of the wiping process, and thus details of the situation (aspect) of the liquid during the wiping process can be known in detail on the basis of the image picked up by the camera.

According to the present disclosure, it is possible to know details of the situation of the liquid during the wiping process.

### BRIEF DESCRIPTION OF DRAWINGS

FIG. 1 is a view depicting a configuration of an observing apparatus 1.

FIG. 2 is a view depicting an example of an image picked up by a camera 33 of the observing apparatus 1.

FIG. 3 is a flow chart of a main process of the observing apparatus 1.

FIG. 4 is a flow chart of a first observing process of the observing apparatus 1.

FIG. 5 is a flow chart of a second observing process of the observing apparatus 1.

FIG. 6 is a flow chart of another first observing process of the observing apparatus 1.

FIG. 7 is a view depicting a configuration of a printer 2.

FIG. 8 is a block diagram depicting a control unit 71 of the printer 2 and peripheral parts of the control unit 71.

FIG. 9A is a view depicting a state before execution of a maintenance process by the control unit 71, FIG. 9B is a view depicting a state during execution of an uncapping empty suction process by the control unit 71, and FIG. 9C is a view depicting a state during execution of a wiping process by the control unit 71.

FIG. 10 is a flow chart of the maintenance process of the printer 2.

FIGS. 11A and 11B are flow charts of another maintenance process of the printer 2.

FIGS. 12A and 12B are flow charts of still another maintenance process of the printer

2.

FIGS. 13A and 13B are flow charts of still another maintenance process of the printer 2.

FIGS. 14A and 14B are flow charts of a printing process of the printer 2.

FIG. 15 is a flow chart of a main process of an observing apparatus.

FIG. 16 is a view depicting a composition table 91 of the observing apparatus.

FIG. 17 is a flow chart of a main process of an observing apparatus.

FIG. 18 is a view depicting a viscosity table 92 of the observing apparatus.

### DESCRIPTION

### [Details of Inks]

Before explaining embodiments of the present disclosure, details of inks to be used in the embodiments of the present disclosure will be explained. The ink includes resin fine particles, a color material, an organic solvent, a surfactant, and water. The ink is water-soluble ink.

Although the ink has a wettability with respect to a hydrophobic recording medium such as coated paper, plastic, film, an OHP sheet, etc., the present disclosure is not limited to this. For example, the ink may be an ink suitable for recording of an image on a recording medium, which is different from the hydrophobic recording medium, such as, for example, plain paper, glossy paper, mat paper, etc. The term “coated paper” means, for example, a paper obtained by applying a coating agent on a plain paper having a pulp as a major component, such as high quality printing paper, medium quality printing paper, etc., for a purpose of improving the smoothness, whiteness, glossiness, etc. Examples of the coated pater are high quality coated paper, medium quality coated paper, etc.

As the resin fine particles, for example, resin fine particles including methacrylic acid and/or acrylic acid as a monomer may be used, and for example, a commercially available product may be used. The resin fine particles may further include, as the monomer, styrene, vinyl chloride, etc. The resin fine particles may be, for example, resin fine particles included in an emulsion. The emulsion is composed, for example, of resin fine particles and a dispersion medium (for example, water, etc.). The resin fine particles are not dissolved in the dispersion medium. The resin fine particles are dispersed in the dispersion medium with a particle diameter of a specific range. Examples of the material of the resin fine particles include, a resin based on acrylic acid, a resin based on maleate ester, a resin based on vinyl acetate, a resin based on carbonate, a resin based on polycarbonate, a resin based on styrene, a resin based on ethylene, a resin based on polyethylene, a resin based on propylene, a resin based on polypropylene, a resin based on urethane, a resin based on polyurethane, a resin based on polyester, and a resin of copolymer of the above-described resins, etc. The resin fine particles may be fine particles of an acrylic resin.

As the resin fine particles, for example, a resin having a glass-transition temperature (Tg) in a range of not less than 0° C. to not more than 200° C. is used. The glass transition temperature (Tg) may be in a range of not less than 20° C. to not more than 180° C., and may be not less than 30° C. to not more than 150° C.

As the emulsion, for example, a commercially available product may be used. The commercially available product is exemplified by “SUPERFLEX 870” (Tg: 71° C.), “SUPERFLEX 150” (Tg: 40° C.) manufactured by DKS CO., LTD; “Mowinyl 6760” (Tg: −28° C.) and “Mowinyl DM774” (Tg: 33° C.) manufactured by Japan Coating Resin Corporation; “Polysol AP-3270N” (Tg: 27° C.) manufactured by Resonac Holding Corporation; “HILOS-X KE-1062” (Tg: 112° C.), and “HILOS-X QE-1042” (Tg: 69° C.) manufactured by SEIKO PMC CORPORATION; etc.

The average particle diameter of the resin fine particles is, for example, in a range of not less than 30 nm to not more than 200 nm. The average particle diameter can be measured by, for example, using a dynamic light scattering particle diameter distribution measuring apparatus “LB-550” manufactured by HORIBA, Ltd., as an arithmetic average diameter.

A content amount (R) of the resin fine particles in the entire amount of the ink may be, for example, within a range of not less than 0.1 wt % to not more than 30 wt %, may be within a range of not less than 0.5 wt % to not more than 20 wt %, and may be within a range of not less than 1.0 wt % to not more than 15.0 wt %. One kind of the resin fine particles may be used singly, or two or more kinds of the resin fine particles may be used in combination.

The color material is, for example, a pigment which is dispersible in water by, for example, a resin for dispersing pigment (resin dispersant). The color material is exemplified by carbon black, an inorganic pigment, an organic pigment, etc. The carbon black is exemplified by furnace black, lamp black, acetylene black, channel black, etc. The inorganic pigment is exemplified by titanium oxide, inorganic pigments based on iron oxide, inorganic pigments based on carbon black, etc. The organic pigment is exemplified by azo-pigments such as azo lake, insoluble azo-pigment, condensed azo-pigment, chelate azo-pigment, etc.; polycyclic pigments such as phthalocyanine pigment, perylene and perinone pigments, anthraquinone pigment, quinacridone pigment, dioxadine pigment, thioindigo pigment, isoindolinone pigment, quinophthalone pigment etc.; dye lake pigments such as basic dye type lake pigment, acid dye type lake pigment etc.; nitro pigment; nitroso pigment; aniline black daylight fluorescent pigment; and the like.

A content of a solid content of the color material in the entire amount of the ink is not particularly limited, and may be appropriately determined according to, for example, a desired optical density or chromaticness, etc. The content of the solid content of the color material is, for example, within a range of not less than 0.1 wt % to not more than 20.0 wt %, and may be within a range of not less than 1.0 wt % to not more than 15.0 wt %. The content of the solid content of the color material is the weight only of the pigment, and does not include the weight of the resin fine particles. One kind of the color material may be used singly, or two or more kinds of the color material may be used in combination.

The organic solvent is not particularly limited, and any organic solvent is usable. The organic solvent is exemplified by: propylene glycol, ethylene glycol, 1,2-butanedioal, propylene glycol monobutyl ether, dipropylene glycol monopropyl ether, triethylene glycol monobutyl ether, 1,2-hexianediol, 1,6-hexianediaol, etc.; and glycol ether having a propylene oxide group may be used. Examples of other organic solvent include, for example, alkylalcohols having a carbon number of 1 to 4 such as: methyl alcohol, ethyl alcohol, n-propyl alcohol, isopropyl alcohol, n-butyl alcohol, sec-butyl alcohol, tert-butyl alcohol, etc.; alkylene glycols in each of which an alkylene group includes 2 to 6 carbon atoms such as: ethylene glycol, propylene glycol, butylene glycol, triethylene glycol, 1,2,6-hexanetriol, thiodiglycol, hexylene glycol, diethylene glycol, etc.; lower alkyl ethers of alkylene glycols such as: glycerol, ethylene glycol monomethyl (or ethyl, propyl, butyl) ether, diethylene glycol monomethyl (or ethyl, propyl, butyl) ether, triethylene glycol monomethyl (or ethyl, propyl, butyl, hexyl) ether, tetraethylene glycol monomethyl (or ethyl, propyl, butyl, hexyl) ether, propylene glycol monomethyl (or ethyl, propyl, butyl) ether, dipropylene glycol monomethyl (or ethyl, propyl, butyl) ether, tripropylene glycol monomethyl (or ethyl, propyl, butyl) ether, tetra propylene glycol monomethyl (or ethyl) ether; N-methyl-2-pyrrolidone; 2-pyrrolidone; 1,3-dimethyl-2-imidazolidinone; etc.

Regarding a content amount of the organic solvent in the entire amount of the ink, an organic solvent which exists in isolated liquid state (that is, as a single substance and as a liquid) at 25° C. may be 50 wt % or less, and may be 40 wt % or less with respect to the entire amount of the ink.

The water is preferably ion-exchange water or purified water. A content amount of the water with respect to the entire amount of the ink may be, for example, within a range of not less than 15 wt % to not more than 95 wt %, and may be within a range of not less than 25 wt % to not more than 85 wt %. The content amount of the water may be, for example, a remainder of the total from which other components are removed.

The ink may further include a conventionally known additive, as necessary. The additive is exemplified by surfactants, pH-adjusting agents, viscosity-adjusting agents, surface tension-adjusting agents, antiseptics, fungicides, levelling agents, antifoaming agents, light stabilizing agents, antioxidants, drying preventive agents for nozzle, polymer components such as emulsion, dye, etc. The surfactants may further include cationic surfactants, anionic surfactants or nonionic surfactants. The surfactants may be commercially available products. The commercially available products are exemplified by “OLFINE E1010”, “OLFINE E1006”, and “OLFINE E1004” (“OLFINE” is a registered trade mark of Nissin Chemical Industry Co., Ltd.), “SILFACE SAG503A”, “SILFACE SAG002” etc. (“SILFACE” is a registered trademark of Nissin Chemical Industry Co., Ltd.) manufactured by Nissin Chemical Industry Co., Ltd. The content amount of the surfactant in the entire amount of the ink is, for example, 5 wt % or less, 3 wt % or less, and in a range of not less than 0.1 wt % and not more than 2 wt %. The viscosity-adjusting agents are exemplified by polyvinyl alcohol, cellulose, water-soluble resin, etc.

The ink can be prepared, for example, by uniformly mixing the resin fine particles, the color material, the organic solvent, the water, and an optionally other additive(s) as necessary, by a conventionally known method, and then removing any non-dissolved matter, with a filter, etc.

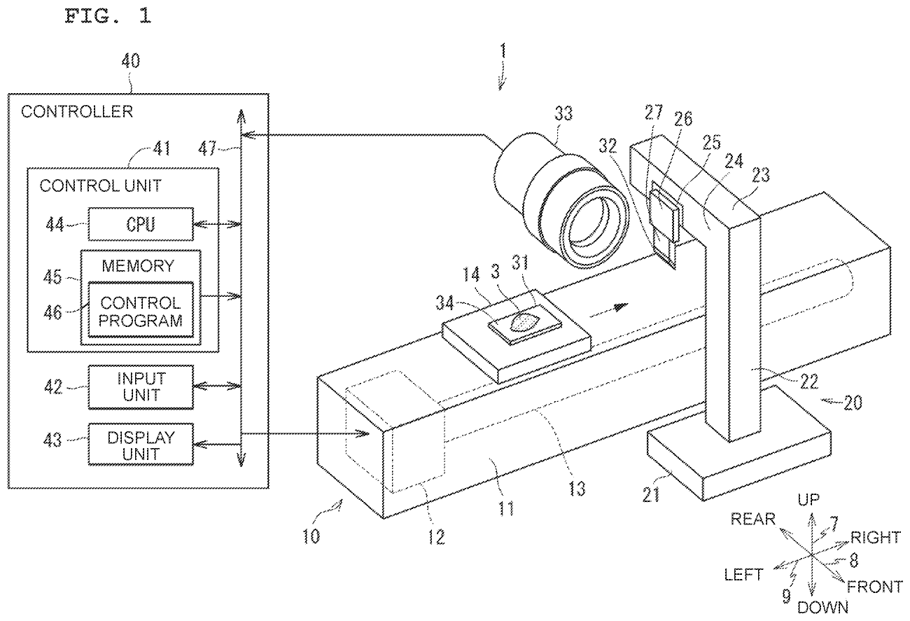

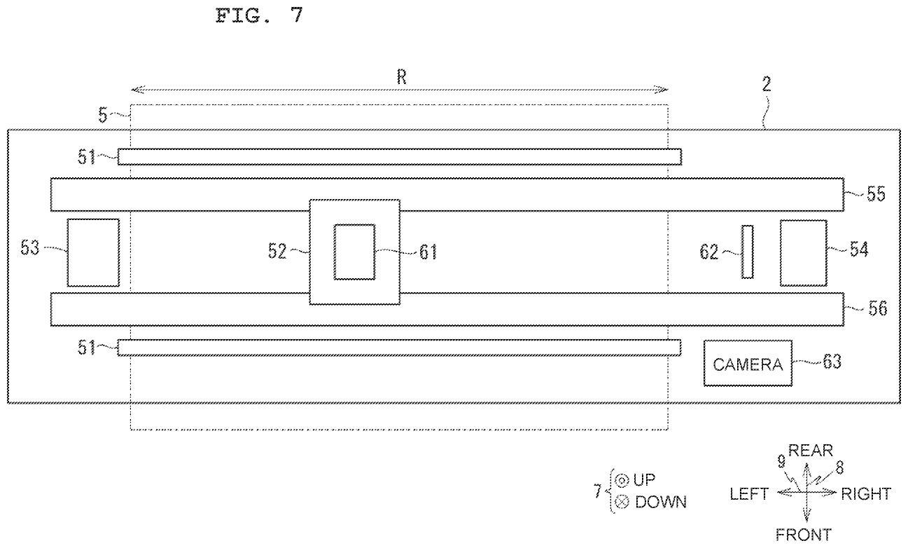

Embodiments of the present disclosure will be described below. Note that the embodiments described below are merely examples of the present disclosure. It goes without saying that the embodiments of the present disclosure can be appropriately changed within a range without changing the gist of the present disclosure. In a first embodiment, an observing apparatus 1 depicted in FIG. 1 will be described. The observing apparatus 1 depicted in FIG. 1 is provided in order to observe the situation of the ink (example of the liquid) during the wiping up. In a second embodiment, a printer 2 depicted in FIG. 7 will be described. The printer 2 depicted in FIG. 7 is an example of the printing apparatus which has the function to observe the situation of the ink during the wiping up. In the following description, the advance directed from the start point to the end point of the arrow is expressed as “orientation”, and the displacement (coming and going) on the line to connect the start point to the end point of the arrow is expressed as “direction”.

### [Configuration of Observing Apparatus 1]

As depicted in FIG. 1, the observing apparatus 1 according to the first embodiment is provided with an electric cylinder 10 having a slider 14, a fixed stand 20, a plate 31, a wiper 32, a camera 33, and a controller 40. The electric cylinder 10 is placed, for example, on a workbench (not depicted) so that the slider 14 is disposed at an upper position. In this embodiment, the up-down direction of the electric cylinder 10 is referred to as “up-down direction 7”, the movement direction of the slider 14 is referred to as “left-right direction 9”, and the direction, which is orthogonal to the up-down direction 7 and to the left-right direction 9, is referred to as “front-rear direction 8”. An example of the electric cylinder is ROBOCYLINDER of IAI Inc.

The electric cylinder 10 has a casing 11 which has an approximately rectangular parallelepiped shape in which the left-right direction 9 is the longitudinal direction. The electric cylinder 10 has a motor 12, a ball screw 13, and the slider 14. The motor 12 is contained at one end (left end in FIG. 1) of the casing 11. The ball screw 13 is contained in the casing 11, and the ball screw 13 extends in the longitudinal direction (left-right direction 9) of the electric cylinder 10. The motor 12 is rotated in accordance with the control performed by the controller 40. The ball screw 13 is rotated in accordance with the rotation of the motor 12, and the slider 14 is moved in the left-right direction 9.

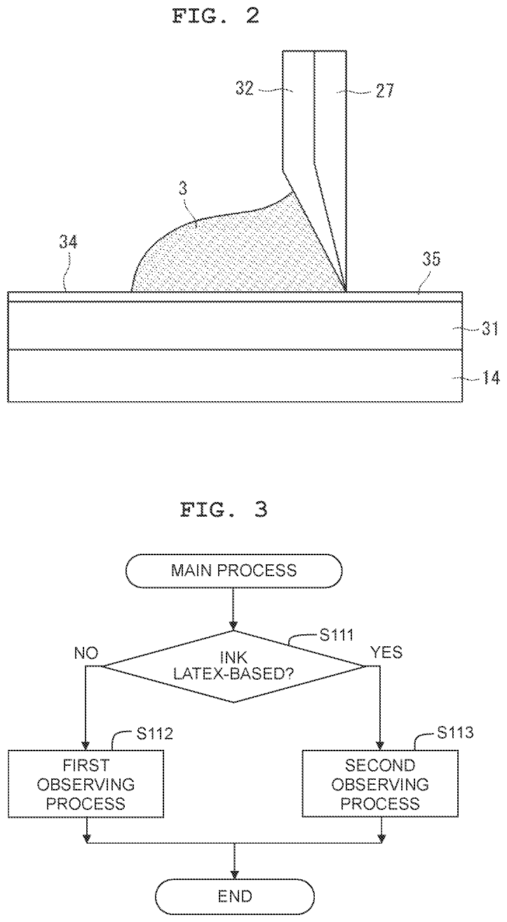

The plate 31 is a thin glass plate. A water-repellent film 35 (see FIG. 2) is applied on the upper surface 34 of the plate 31 (hereinafter, the upper surface of the water-repellent film 35 is also referred to as “upper surface 34 of the plate 31”). The plate 31 is placed on the slider 14, and the plate 31 is fixed to the upper surface of the slider 14. The plate 31 is movable in the left-right direction 9 together with the slider 14. The slider 14 is an example of a stand. The plate 31 is an example of a first member. The upper surface 34 is an example of a first surface.

The fixed stand 20 has a pedestal 21, a vertical portion 22, and a horizontal portion 23. The pedestal 21 has a flat plate shape which extends in the front-rear direction 8 and the left-right direction 9. The fixed stand 20 is placed, for example, on the workbench so that the lower surface of the pedestal 21 is brought in contact with, for example, the workbench. The vertical portion 22 has an approximately rectangular parallelepiped shape, and the vertical portion 22 extends upwardly from the pedestal 21. The horizontal portion 23 has an approximately rectangular parallelepiped shape, and the horizontal portion 23 extends rearwardly from the upper end of the vertical portion 22.

A support member 25 is provided on the left side surface 24 of the horizontal portion 23. The support member 25 supports the wiper 32 by the aid of a spring 26 and a wiper attachment portion 27. The spring 26 is, for example, a plate-shaped spring. The wiper 32 is a thin plate-shaped member made of rubber. The width (size in the front-rear direction 8) of the wiper 32 is, for example, 3 mm. The upper end of the spring 26 is attached to the support member 25. The lower end of the spring 26 is connected to the upper end of the wiper attachment portion 27. The wiper 32 is secured to the lower end of the wiper attachment portion 27 by means of, for example, an adhesive.

The observing apparatus 1 executes a main process (FIG. 3) in a state in which a predetermined amount of the ink 3 is adhered to the upper surface 34 of the plate 31. The ink 3 is the ink which is the object of the observation with the observing apparatus 1. The predetermined amount is, for example, 20 μl. In the main process, the slider 14 and the plate 31 are moved rightwardly by means of the electric cylinder 10. Here, the sizes of the vertical portion 22 and the horizontal portion 23 of the fixed stand 20 are determined so that the plate 31 passes through the space disposed in the vicinity of the lower end of the wiper 32 in this situation, and the wiper 32 wipes up the ink 3 adhered to the plate 31. The plate 31 is moved in the left-right direction 9 in the state in which the wiper 32 is fixed, and thus the wiper 32 is relatively moved in the left-right direction 9 with respect to the plate 31. The left-right direction 9 is an example of a first direction.

The pressing pressure, which is exerted on the plate 31 by the wiper 32, is changeable. Specifically, the support member 25 is configured so that the support angle of the wiper 32 is changeable. In other words, the wiper 32 is supported by the support member 25 in a manner that the support angle of the wiper 32 is changeable. The spring 26 is replaceable with respect to the fixed stand 20. The wiper 32 is fixed at approximately the same position as the position of the camera 33 in the up-down direction 7 and the left-right direction 9 by the aid of the replaceable spring 26. This position is an example of a predetermined position. The position in the up-down direction 7 of the wiper 32 is configured to be changeable. On this account, the distance between the wiper 32 and the water-repellent film 35 formed on the upper surface 34 of the plate 31 is changeable. The water-repellent film 35 and the wiper 32 are in a non-contact state throughout the wiping process from the beginning of the wiping up of the ink 3 to the end of the wiping up of the ink 3. The distance between the water-repellent film 35 and the wiper 32 is, for example, not less than 0.1 mm and not more than 1.0 mm. The distance between the water-repellent film 35 and the wiper 32 is set, for example, to 0.7 mm.

The feature that the water-repellent film 35 and the wiper 32 are in the non-contact state will now be explained in detail below. The application of the water-repellent film 35 is uneven, and hence the surface of the water-repellent film 35 is not any uniform flat surface. Further, the forward end of the wiper 32 is cut by cutting means (for example, scissors or a cutter), wherein the cut surface disposed at the forward end of the wiper 32 is not any uniform flat surface as well. On this account, in a state in which the water-repellent film 35 and the wiper 32 sufficiently approach to one another, portions at which the water-repellent film 35 and the wiper 32 are brought in contact and portions at which the water-repellent film 35 and the wiper 32 are not brought in contact exist. The distance, which is not less than 0.1 mm and not more than 1.0 mm as described above, is provided at the portions at which the water-repellent film 35 and the wiper 32 are not brought in contact. Therefore, if the plate 31, to which the ink 3 is adhered, is moved, for example, rightwardly in the state in which the wiper 32 is fixed, the ink 3 is once obstructed by the left surface of the wiper 32 when the ink 3 placed on the plate 31 arrives at the position of the wiper 32. However, a part of the ink 3 thereafter passes through the non-contact portion between the water-repellent film 35 and the wiper 32, and the part of the ink 3 moves to the right side of the wiper 32. The part of the ink 3, which has moved to the right side of the wiper 32, follows the wiper 32 in some cases or does not follow the wiper 32 in other cases depending on, for example, the pressing pressure of the wiper 32 with respect to the plate 31, the support angle of the wiper 32, and the distance between the water-repellent film 35 and the wiper 32. In the present disclosure, the wording of “non-contact state” means a state in which at least a part of the water-repellent film 35 (or the first member) and at least a part of the wiper 32 are not in contact with each other. In the “non-contact state”, a part of the water-repellent film 35 (or the first member) and a part of the wiper 32 may be in contact with each other.

The camera 33 is a camera which contains a microscope. The camera 33 is positioned at approximately the same position as the position of the wiper 32 in the up-down direction 7 and the left-right direction 9 at the rear of the electric cylinder 10. The camera 33 picks up an image of the wiper 32 and the vicinity of the wiper 32 from the position disposed at the rear of the electric cylinder 10. When the wiper 32 moves relative to the plate 31 in the left-right direction 9, the camera 33 picks up, in the front-rear direction 8, the image of the process in which the wiper 32 wipes up the ink 3. The camera 33 is an example of a camera (image pickup unit). The front-rear direction 8 is an example of a second direction intersecting a first direction and a facing direction.

The camera 33 picks up the image, for example, depicted in FIG. 2. The image depicted in FIG. 2 depicts such a situation that the wiper 32, which is attached to the wiper attachment portion 27, wipes up the ink 3 adhered to the upper surface 34 of the plate 31 placed on the slider 14.

As depicted in FIG. 1, the controller 40 is provided with a control unit 41, an input unit 42, and a display unit 43. The input unit 42 is, for example, a mouse and/or a touch panel. The display unit 43 is, for example, a liquid crystal display. The control unit 41 includes a CPU 44 and a memory 45. The memory 45 includes, for example, ROM, RAM and the like. The memory 45 stores a control program 46. The input unit 42, the display unit 43, the CPU 44, and the memory 45 are connected to a bus 47 in the controller 40. For example, the motor 12 of the electric cylinder 10 and the camera 33 are also connected to the bus 47.

The CPU 44 executes the main process (FIG. 3) by executing the control program 46 stored in the memory 45. The CPU 44 and the memory 45 function as the control unit 41. The control unit 41 outputs a control signal to the motor 12, and thus the control unit 41 controls the movement/stop of the slider 14 and the movement velocity of the slider 14. The control unit 41 outputs a control signal to the camera 33, and thus the control unit 41 controls the image pickup start/stop of the camera 33. The control unit 41 determines whether or not the ink 3 follows the wiper 32 on the basis of the image picked up or photographed by the camera 33. The control unit 41 executes the process as described later on in accordance with the result of the determination. The controller 40 is realized, for example, by a personal computer. The controller 40 and/or the control unit 41 are/is example(s) of a controller. The control program 46 is an example of a program.

Note that the control program 46 may be stored on a storage medium which can be read by the computer. The storage medium, which can be read by the computer, is a non-transitory medium. The non-transitory medium includes recording media such as CD-ROM, DVD-ROM and the like. Further, the non-transitory medium is also a tangible medium. On the other hand, the electric signal, which transports the program downloaded, for example, from a server on the internet, is the signal medium or vehicle that can be read by the computer, as one type of the medium which can be read by the computer. However, the electric signal is not included in the storage medium which is non-transitory and which can be read by the computer.

According to the observing apparatus 1 as described above, information or an image indicating the situation in which the ink 3 adhered to the upper surface 34 of the plate 31 is wiped up with the wiper 32 can be obtained. The obtained result is referred to upon the design of the printing apparatus. The obtained result is referred to, for example, when the ink to be used for the printing apparatus is selected and when the movement velocity of the wiper, the pressing pressure of the wiper, and the support angle of the wiper are determined in the printing apparatus.

### [Main Process]

The control unit 41 executes the main process depicted in FIG. 3 in accordance with the reception of an instruction from a user via the input unit 42. The user drops the predetermined amount of the ink 3 onto the upper surface 34 of the plate 31 before the instruction of the execution of the main process. In a state before the execution of the main process, the slider 14 and the plate 31 are positions at the initial positions disposed on the left of the wiper 32, and the ink 3 is adhered to the upper surface 34 of the plate 31.

As depicted in FIG. 3, the control unit 41 determines whether or not the ink 3 on the plate 31 is the latex-based ink at the beginning of the main process (S111). In S111, the control unit 41 causes the display unit 43 to display a message “Ink to be used latex-based ink?”. The control unit 41 determines whether or not the ink 3 is the latex-based ink in accordance with the input of any one of Yes and No from the input unit 42.

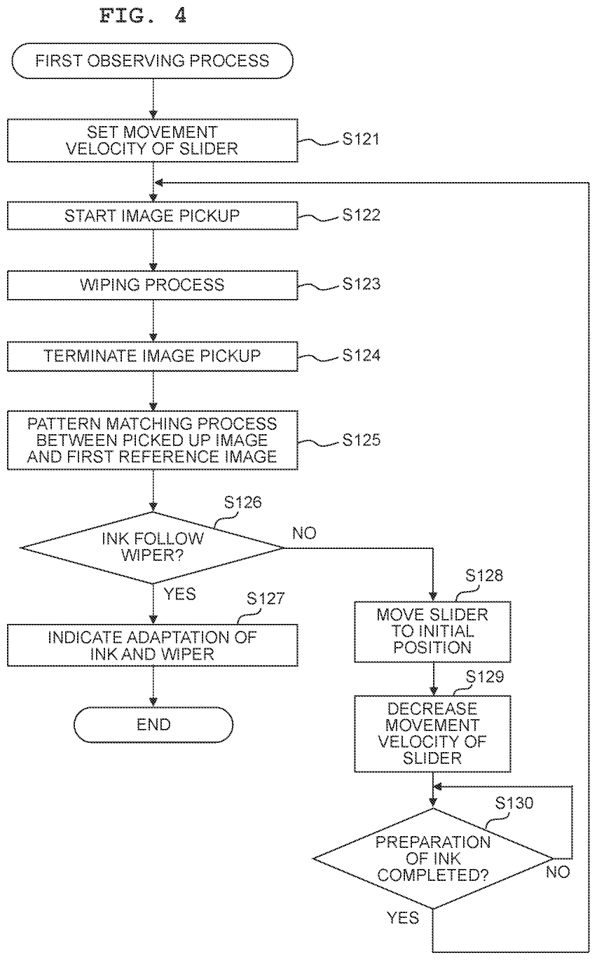

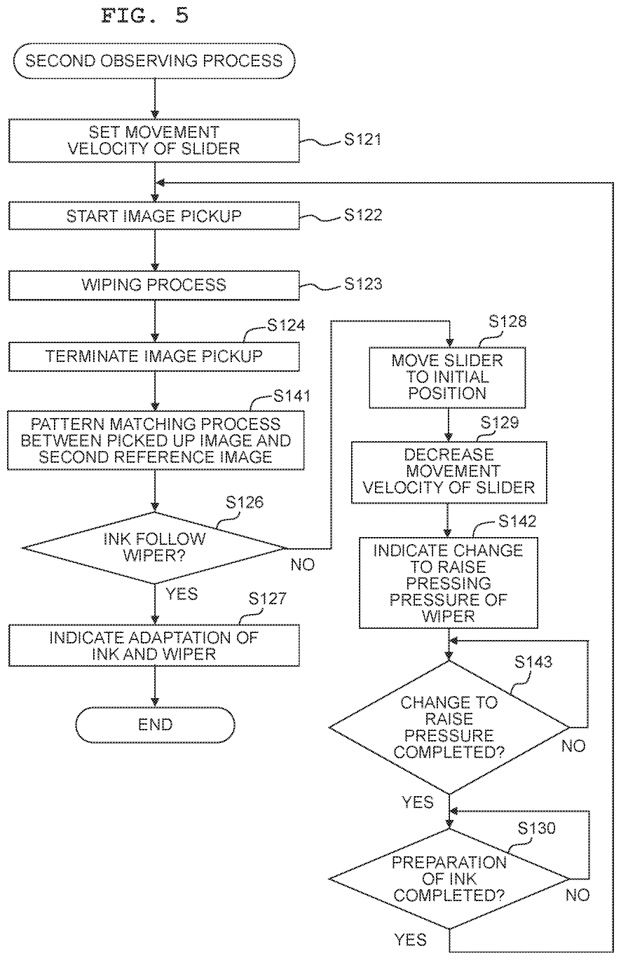

The control unit 41 proceeds to S112 in accordance with the determination that the ink 3 is not the latex-based ink (S111: No). In this case, the control unit 41 executes a first observing process depicted in FIG. 4 (S112). The control unit 41 proceeds to S113 in accordance with the determination that the ink 3 is the latex-based ink (S111: Yes) in S111. In this case, the control unit 41 executes a second observing process depicted in FIG. 5 (S113). The control unit 41 terminates the main process after executing S112 or S113. Note that the latex-based ink is an example of an ink having high viscosity. S113 is executed in accordance with the determination that the ink 3 is the latex-based ink. Therefore, S113 is an example of a high viscosity state process to be executed depending on the viscosity of the ink 3.

### [First Observing Process]

As depicted in FIG. 4, the control unit 41 sets the movement velocity of the slider 14 at the beginning of the first observing process (S121). The control unit 41 outputs a control signal to indicate the movement velocity of the slider 14 to the motor 12 in S121. Accordingly, the control unit 41 sets the movement velocity of the slider 14. Subsequently, the control unit 41 causes the camera 33 to start the image pickup (S122). After the control unit 41 executes S122, the camera 33 picks up the image of the wiper 32 and the vicinity of the wiper 32.

Subsequently, the control unit 41 executes the wiping process (S123). In S123, the control unit 41 drives the motor 12 for a predetermined time to move the slider 14 and the plate 31 by a predetermined amount rightwardly from the initial position so that the ink 3, which is adhered to the upper surface 34 of the plate 31, is wiped up with the wiper 32.

Subsequently, the control unit 41 causes the camera 33 to terminate the image pickup (S124). When the control unit 41 executes S124, the camera 33 terminates the image pickup for the wiper 32 and the vicinity of the wiper 32. In this manner, the camera 33 picks up the image of the process of wiping up the ink 3 adhered to the upper surface 34 of the plate 31 with the wiper 32 from the beginning to the end of the wiping process.

Subsequently, the control unit 41 executes the pattern matching process between the image picked up by the camera 33 and a previously prepared first reference image (S125). The first reference image is a so-called template image in the pattern matching process. For example, an image, obtained previously by imaging the situation in which the ink that is not latex-based follows the wiper 32 and wiped up with the wiper 32, is used for the first reference image. The first reference image may be an image obtained by partially changing the image in which the situation in which the ink that is not latex-based follows the wiper 32 and wiped up with the wiper 32 is subjected to the image pickup, or an artificially prepared image having the same or equivalent feature as that of the image in which the situation in which the ink that is not latex-based follows the wiper 32 and wiped up with the wiper 32 is subjected to the image pickup.

Subsequently, the control unit 41 determines whether or not the ink 3 follows the wiper 32 on the basis of the result of the pattern matching process in S125 (S126). In S126, the control unit 41 determines that the ink 3 follows the wiper 32 in accordance with the matching between the two images. S126 is an example of the first determining process.

An explanation will now be made about specified examples of the pattern matching process executed in S125 and the first determining process executed in S126. For example, the control unit 41 may perform the following procedure. That is, the control unit 41 may obtain the sum of differences of pixel values between the picked up image and the first reference image (template image), in the pattern matching process. In the first determining process, the control unit 41 compares the sum obtained in the pattern matching process and a predetermined threshold value. If the sum is smaller than the threshold value, the control unit 41 may determine that the two images match and the ink 3 follows the wiper 32. In this case, for example, an image, which is obtained by partially changing the first reference image, may be added to the template image, and the same or equivalent process may be performed for the added image. By doing so, whether or not the ink 3 follows the wiper 32 can be determined more preferably.

Alternatively, the control unit 41 may perform the following procedure. That is, in the pattern matching process, the control unit 41 moves the first reference image (template image), for example, by one pixel upwardly, downwardly, leftwardly, and rightwardly in the picked up image; and find the minimum value of the sum of differences of pixel values between the template image and the picked up image disposed at the position of the template image. In the first determining process, the control unit 41 compares the minimum value, which is found in the pattern matching process, with a predetermined threshold value. In a case where the minimum value is smaller than the threshold value, the control unit 41 may determine that the picked up image and the first reference image match and the ink 3 follows the wiper 32.

In this case, the following procedure is also available. That is, the control unit 41 executes the pattern matching process at three stages by using, as the template image, a first reduction image and a second reduction image (provided that the number of pixels of the second reduction image is larger than the number of pixels of the first reduction image) in which the number of pixels of the first reference image is decreased. In the process at the first stage (also referred to as “primary screening”), the control unit 41 finds one or more position or positions (position or positions at which the sum of differences of pixel values is smaller than a threshold value) at which the two images match between the first reduction image and the picked up image reduced at the same reduction rate as that of the first reduction image. In the process at the second stage (also referred to as “secondary screening”), the control unit 41 finds one or more position or positions at which the two images match between the second reduction image and the picked up image reduced at the same reduction rate as that of the second reduction image in relation to the position or positions found in the process at the first stage. In the process at the third stage, the control unit 41 finds the minimum value of the sum of differences of pixel values between the original first reference image and the original picked up image in relation to the position or positions found in the process at the second stage. In the first determining process, the control unit 41 compares the minimum value found in the pattern matching process with a predetermined threshold value. If the minimum value is smaller than the threshold value, the control unit 41 determines that the picked up image and the first reference image matches and the ink 3 follows the wiper 32. Note that the control unit 41 may perform the matching between the two images by moving the first reference image upwardly, downwardly, leftwardly, and rightwardly, for example, by 0.5 pixel in the picked up image in the process at the third stage. Further, the control unit 41 may execute the pattern matching process at two stages, or the control unit 41 may execute the pattern matching process at four or more stages.

The control unit 41 proceeds to S127 in accordance with the determination that the ink 3 follows the wiper 32 (S126: Yes). In this case, the control unit 41 causes the display unit 43 to indicate that the ink 3 and the wiper 32 are adapted to one another (S127). S127 is an example of an adaptation indication process. After that, the control unit 41 terminates the first observing process and the main process.

The control unit 41 proceeds to S128 in accordance with the determination that the ink 3 does not follow the wiper 32 in S126 (S126: No). In this case, the control unit 41 moves the slider 14 to the initial position (S128). In S128, the control unit 41 drives the motor 12 for a predetermined time period to move the slider 14 and the plate 31 leftwardly to the initial position.

Subsequently, the control unit 41 decreases (slows) the movement velocity of the slider 14 (S129). According to an experiment performed by the applicant, the following tendency is provided between the relative velocity of the wiper 32 with respect to the ink 3 (in other words, the movement velocity of the slider 14) and the followability of the ink 3 with respect to the wiper 32. If the relative velocity of the wiper 32 is large, then the ink 3 cannot follow the movement of the wiper 32, the ink 3 is stretched, and the ink 3 remains on the upper surface 34 of the plate 31 in a divided state. On the other hand, if the relative velocity of the wiper 32 is small, then the ink 3 is more likely to follow the movement of the wiper 32, and the ink 3 is less likely to be stretched and remain. The control unit 41 decreases the movement velocity of the slider 14 by outputting, to the motor 12, a control signal which indicates a movement velocity slower than the present movement velocity of the slider 14 in S129. Accordingly, the relative velocity of the wiper 32 with respect to the plate 31 is decreased, and the ink 3 is more likely to follow the wiper 32. S129 is an example of a first velocity decreasing process.

In a case where the user recognizes that the slider 14 moves to the initial position without indicating the adaptation between the ink 3 and the wiper 32 on the display unit 43, the user prepares another ink in order to perform the next observation. The user wipes up, with cloth or the like, the ink which remains on the upper surface 34 of the plate 31 and the ink which has been subjected to the wiping up with the wiper 32. The user drops a predetermined amount of the ink onto the upper surface 34 of the plate 31.

The control unit 41 waits in S130 until the preparation of the ink is completed after executing S129. More specifically, the control unit 41 determines whether or not the preparation of the ink is completed in S130. The control unit 41 causes the display unit 43 to display, for example, a message “Preparation of ink completed?”. The control unit 41 determines that the preparation of the ink is completed in accordance with the input of “Yes” from the input unit 42.

The control unit 41 executes S130 again in accordance with the determination that the preparation of the ink is not completed in S130 (S130: No). The control unit 41 proceeds to S122 in accordance with the determination that the preparation of the ink is completed in S130 (S130: Yes). In this case, the control unit 41 executes the process of S122 and the followings again.

### [Second Observing Process]

The second observing process depicted in FIG. 5 is obtained by modifying the first observing process depicted in FIG. 4 such that S125 is replaced with S141, and S142 and S143 are added. The control unit 41 sets the movement velocity of the slider 14 at the beginning of the second observing process (S121). Subsequently, the control unit 41 causes the camera 33 to start the image pickup (S122), executes the wiping process (S123), and causes the camera 33 to terminate the image pickup (S124). The camera 33 picks up the image of the process of wiping up the ink 3 adhered to the upper surface 34 of the plate 31 with the wiper 32 from the beginning to the end of the wiping process.

Subsequently, the control unit 41 executes the pattern matching process between the image picked up by the camera 33 and a previously prepared second reference image (S141). The second reference image is a template image which is different from the first reference image. For example, an image which is obtained by previously picking up an image of the situation in which the latex-based ink follows the wiper 32 and wiped up with the wiper 32, an image which is obtained by partially changing the image obtained by previously picking up the image of the situation in which the latex-based ink follows the wiper 32 and wiped up with the wiper 32, or an artificially prepared image having the same or equivalent feature as that of the image which is obtained by picking up the image of the situation in which the latex-based ink follows the wiper 32 and wiped up with the wiper 32 is used for the second reference image.

Subsequently, the control unit 41 determines whether or not the ink 3 follows the wiper 32 on the basis of the result of the pattern matching process in S141 (S126). S141 and S126 are examples of the first determining process. The control unit 41 proceeds to S127 in accordance with the determination that the ink 3 follows the wiper 32 (S126: Yes). In this case, the control unit 41 causes the display unit 43 to indicate that the ink 3 and the wiper 32 are adapted to one another (S127), then the control unit 41 terminates the second observing process and the main process.

The control unit 41 proceeds to S128 in accordance with the determination that the ink 3 does not follow the wiper 32 in S126 (S126: No). In this case, the controller 40 moves the slider 14 to the initial position (S128). The controller 40 decreases the movement velocity of the slider 14 (S129), and the controller 40 proceeds to S142.

Subsequently, the control unit 41 causes the display unit 43 to perform indication urging the user to raise the pressing pressure of the wiper 32 (S142). The control unit 41 causes the display unit 43 to display, for example, a message “Make change to raise pressing pressure of wiper” in S142. When the user sees the message displayed on the display unit 43, the user makes the change to raise the pressing pressure of the wiper 32. The user makes, for example, the change to increase the support angle of the wiper 32, the change to use the spring 26 having a large elastic force, or the change to shorten the distance between the water-repellent film 35 and the wiper 32. S142 is an example of an urging indication process. Note that an example of the change to increase the support angle is a procedure in which the wiper 32 is inclined so that the lower end portion of the wiper 32 is positioned on the left of the upper end portion of the wiper 32 in FIG. 1.

The control unit 41 may cause the display unit 43 to perform indication urging the user to increase the support angle of the wiper 32. That is, the control unit 41 determines whether or not the ink 3 follows the wiper 32 in S126 on the basis of the result of the pattern matching process in S141. The control unit 41 executes S128 and S129 in accordance with the determination that the ink 3 does not follow the wiper 32 in S126. After that, the control unit 41 causes the display unit 43 to perform the indication urging the user to increase the support angle of the wiper 32 in S142. When the control unit 41 causes the display unit 43 to perform the indication urging the user to increase the support angle of the wiper 32, the user makes the change to increase the support angle of the wiper 32. In this case, S142 is an example of a first indication process.

The control unit 41 may cause the display unit 43 to perform indication urging the user to increase the elastic force of the spring 26 in S142. That is, the control unit 41 determines whether or not the ink 3 follows the wiper 32 in S126 on the basis of the result of the pattern matching process in S141. The control unit 41 executes S128 and S129 in accordance with the determination that the ink 3 does not follow the wiper 32 in S126. After that, the control unit 41 causes the display unit 43 to perform indication urging the user to increase the elastic force of the spring 26 in S142. When the control unit 41 causes the display unit 43 to perform indication urging the user to increase the elastic force of the spring 26, the user makes the change to increase the elastic force of the spring 26. In this case, S142 is an example of a second indication process.

The control unit 41 may cause the display unit 43 to perform indication urging the user to shorten the distance between the water-repellent film 35 and the wiper 32 in S142. That is, the control unit 41 determines whether or not the ink 3 follows the wiper 32 in S126 on the basis of the result of the pattern matching process in S141. The control unit 41 executes S128 and S129 in accordance with the determination that the ink 3 does not follow the wiper 32 in S126. After that, the control unit 41 causes the display unit 43 to perform indication urging the user to shorten the distance between the water-repellent film 35 and the wiper 32 in S142. When the control unit 41 causes the display unit 43 to perform indication urging the user to shorten the distance between the water-repellent film 35 and the wiper 32, the user makes the change to lower the position in the up-down direction 7 of the wiper 32 so that the distance between the water-repellent film 35 and the wiper 32 is shortened. In this case, S142 is an example of a third indication process. The pressing pressure of the wiper 32 can be raised by performing at least one of the three types of changes by the user.

The control unit 41 waits in S143 until the change of the pressing pressure is completed after executing S142. More specifically, the control unit 41 determines whether or not the change of the pressing pressure is completed in S143. The control unit 41 causes the display unit 43 to display, for example, a message “Change of pressing pressure completed?”. The control unit 41 determines that the change of the pressing pressure is completed in accordance with the input of “Yes” from the input unit 42.

The control unit 41 executes S143 again in accordance with the determination that the change of the pressing pressure is not completed in S143 (S143: No). The control unit 41 proceeds to S130 in accordance with the determination that the change of the pressing pressure is completed in S143 (S143: Yes).

After the determination of “Yes” in S143, the control unit 41 waits in S130 until the preparation of the ink is completed. The control unit 41 executes S130 again in accordance with the determination that the preparation of the ink is not completed in S130 (S130: No). The control unit 41 proceeds to S122 in accordance with the determination that the preparation of the ink is completed in S130 (S130: Yes). In the case of the latter, the control unit 41 executes the process of S122 and the followings again.

The control unit 41 executes the pattern matching process between the picked up image and the first reference image in S125. The control unit 41 executes the pattern matching process between the picked up image and the second reference image in S141. In this manner, the control unit 41 switches the reference image to be used for the pattern matching process depending on the viscosity of the ink 3. S125, S126, and S141 are examples of a second determining process. S125 and S141 are examples of a switching process.

### [Another First Observing Process]

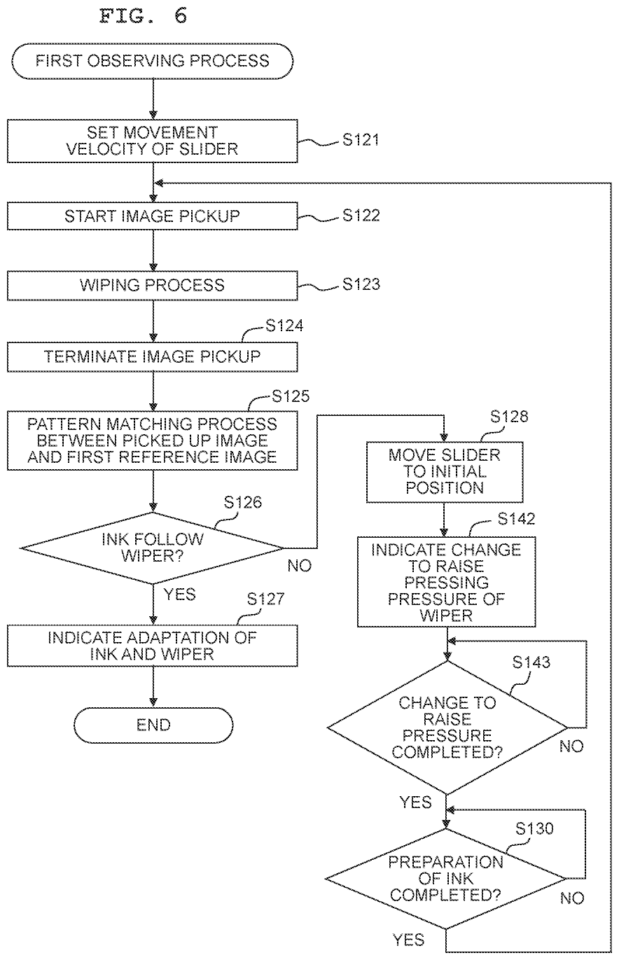

The control unit 41 may execute the first observing process depicted in FIG. 6 in place of the first observing process depicted in FIG. 4. The first observing process depicted in FIG. 6 is obtained by replacing S129 with S142 and S143 in the first observing process depicted in FIG. 4.

In the first observing process depicted in FIG. 6, the control unit 41 proceeds to S142 after executing S128. Subsequently, the control unit 41 causes the display unit 43 to perform indication urging the user to raise the pressing pressure of the wiper 32 (S142). The control unit 41 waits in S143 until the change of the pressing pressure is completed. The control unit 41 proceeds to S130 in accordance with the determination that the change of the pressing pressure is completed in S143 (S143: Yes). The control unit 41 waits in S130 until the preparation of the ink is completed. The control unit 41 proceeds to S122 in accordance with the determination that the preparation of the ink is completed (S130: Yes). In this case, the control unit 41 executes the process of S122 and the followings again.

### [Function and Effect of First Embodiment]

As described above, the observing apparatus 1 according to this embodiment includes the plate 31 (first member) which has the upper surface 34 (first surface) to be subjected to the adhesion of the ink 3 (liquid), the wiper 32 which is relatively movable with respect to the plate 31 and which wipes up the ink 3 adhered to the upper surface 34, and the camera 33 (image pickup unit) which picks up the image of the process of wiping up the ink 3 adhered to the upper surface 34 with the wiper 32 from the beginning to the end of the wiping process. The observing apparatus 1 executes the observing method including the step of relatively moving the wiper 32 with respect to the plate 31 and wiping up the ink 3 adhered to the upper surface 34 with the wiper 32, and the step of picking up the image of the process of wiping up the ink 3 adhered to the upper surface 34 with the wiper 32 from the beginning to the end of the wiping process by means of the camera 33. The control program 46 (program) causes the controller 40 and the control unit 41 (computer) to execute the observing method described above.

Therefore, according to the observing apparatus 1, the observing method executed by the observing apparatus 1, and the control program 46, the image of the process of wiping up the ink 3 adhered to the upper surface 34 with the wiper 32 is picked up from the beginning to the end of the wiping process, and thus the situation of the ink 3 during the wiping process can be known in detail, on the basis of the image picked up by the camera 33.

Further, wiper 32 relatively moves in the left-right direction 9 (first direction) with respect to the plate 31, and the camera 33 picks up, in the front-rear direction 8 (second direction), the image of the process of wiping up the ink 3 with the wiper 32. In this manner, the image is picked up in the direction intersecting the direction in which the wiper 32 moves relatively with respect to the plate 31, and thus the image of the process of wiping up the ink 3 with the wiper 32 can be picked up in the preferred direction. Further, the wiper 32 is fixed, and the plate 31 is movable in the left-right direction 9. In this manner, the image of the process of wiping up the ink 3 with the wiper 32 can be picked up in a state in which the wiper 32 is fixed and the plate 31 is moved.

Further, the observing apparatus 1 is provided with the slider 14 (stand) on which the plate 31 is placed, and the electric cylinder 10 which moves the slider 14. The plate 31 is movable in the left-right direction 9 by means of the electric cylinder 10. Therefore, the plate 31 can be moved in the left-right direction 9 at the desired velocity by means of the electric cylinder 10.

Further, the pressing pressure of the wiper 32 with respect to the plate 31 can be changed. Therefore, the ink 3 can be wiped with changed pressure by changing the pressing pressure of the wiper 32 exerted on the plate 31. Further, the wiper 32 is supported by the support member 25 so that the support angle is changeable. Therefore, the pressing pressure of the wiper 32 can be changed by changing the support angle of the wiper 32. Further, the wiper 32 is fixed at approximately the same position (predetermined position) as the position of the camera 33 in the up-down direction 7 and the left-right direction 9 by the aid of the replaceable spring 26. Therefore, the pressing pressure of the wiper 32 can be changed by replacing the spring 26 so that the elastic force of the spring 26 is changed. Further, the water-repellent film 35 is formed on the upper surface 34, and the distance between the water-repellent film 35 and the wiper 32 is changeable. Therefore, the pressing pressure of the wiper 32 can be changed by changing the distance between the wiper 32 and the water-repellent film 35 disposed on the upper surface 34.

Further, the observing apparatus 1 is provided with the control unit 41 and the display unit 43. The control unit 41 executes the first determining process (S126) for determining whether or not the ink 3 follows the wiper 32 on the basis of the image picked up by the camera 33. The control unit 41 execute the first velocity decreasing process (S129) of decreasing the relative velocity of the wiper 32 with respect to the plate 31 by decreasing the movement velocity of the slider 14 in accordance with the determination that the ink 3 does not follow the wiper 32. Therefore, in a case where the ink 3 does not follow the wiper 32, the wiping residue of the ink 3 can be reduced by decreasing the relative velocity of the wiper 32 with respect to the plate 31.

Further, the control unit 41 executes the first determining process, and executes the urging indication process (S142) of causing the display unit 43 to perform indication urging the user to raise the pressing pressure of the wiper 32 in accordance with the determination that the ink 3 does not follow the wiper 32. Therefore, in a case where the ink 3 does not follow the wiper 32, the user can recognize that the pressing pressure of the wiper 32 should be raised.

Further, the control unit 41 executes, as the urging indication process, the first indication process (S142) of causing the display unit 43 to perform indication urging the user to increase the support angle of the wiper 32. Therefore, in a case where the ink 3 does not follow the wiper 32, the user can recognize that the support angle of the wiper 32 should be increased.

Further, the control unit 41 executes, as the urging indication process, the second indication process (S142) of causing the display unit 43 to perform indication urging the user to increase the elastic force of the spring 26. Therefore, in a case where the ink 3 does not follow the wiper 32, the user can recognize that the elastic force of the spring 26 should be increased.

Further, the control unit 41 executes, as the urging indication process, the third indication process (S142) of causing the display unit 43 to perform indication urging the user to shorten the distance between the water-repellent film 35 and the wiper 32. Therefore, in a case where the ink 3 does not follow the wiper 32, the user can recognize that the distance between the water-repellent film 35 and the wiper 32 should be shortened.

Further, the control unit 41 executes the first determining process, and executes the adaptation indication process (S127) of causing the display unit 43 to indicate the adaptation of the ink 3 and the wiper 32 in accordance with the determination that the ink 3 follows the wiper 32. Therefore, in a case where the ink 3 follows the wiper 32, the user can recognize that the ink 3 and the wiper 32 are adapted to one another.

Further, the water-repellent film 35 is applied to the upper surface 34, and the water-repellent film 35 and the wiper 32 are always in the non-contact state. Further, the distance between the water-repellent film 35 and the wiper 32 is not less than 0.1 mm and not more than 1.0 mm. In a case where the water-repellent film 35 and the wiper 32 are always in the non-contact state, as well as in a case where the distance between the water-repellent film 35 and the wiper 32 is not less than 0.1 mm and not more than 1.0 mm, the ink 3 adhered to the water-repellent film 35 can be wiped with the wiper 32, by the relative movement of the wiper 32 with respect to the plate 31.

Further, the control unit 41 executes the second observing process (high viscosity state process) depending on the viscosity of the ink 3. The control unit 41 executes the first determining process (S126) in the second observing process. The control unit 41 executes the first velocity decreasing process (S129) and the urging indication process (S142) in accordance with the determination that the ink 3 does not follow the wiper 32. Therefore, in the second observing process, in a case where the ink 3 does not follow the wiper 32, the user can recognize that the pressing pressure of the wiper 32 should be raised. The wiping residue of the ink 3 can be further decreased by decreasing the relative velocity of the wiper 32 with respect to the plate 31 by the observing apparatus 1 and raising the pressing pressure of the wiper 32 with respect to the plate 31 by the user.

Further, the control unit 41 executes the first determining process (S126). Before executing the first determining process, the control unit 41 executes the pattern matching process (S141) between the reference image and the image picked up by the camera 33 and the switching process (S125, S141) of switching the reference image to be used for the pattern matching process depending on the viscosity of the ink 3. Whether or not the ink 3 follows the wiper 32 can be determined depending on the viscosity of the ink 3 by switching the reference image to be used for the pattern matching process depending on the viscosity of the liquid of the ink 3.

### [Configuration of Printer 2]

As depicted in FIG. 7, a printer 2 according to a second embodiment includes a conveying unit 51, a carriage 52, a flashing receiving unit 53, a cap 54, a head 61 which is carried on the carriage 52, a wiper 62, and a camera 63. The printer 2 is placed, for example, on a desk or a rack so that the carriage 52 is movable in the horizontal direction. In this embodiment, the up-down direction of the printer 2 is referred to as “up-down direction 7”, the direction in which the carriage 52 is movable is referred to as “left-right direction 9”, and the direction which is orthogonal to the up-down direction 7 and orthogonal to the left-right direction 9 is referred to as “front-rear direction 8”.

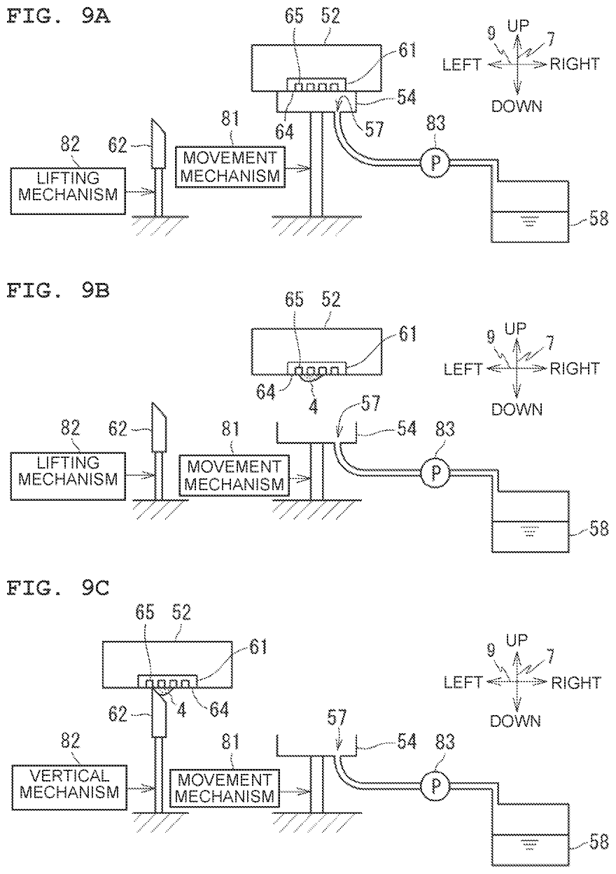

Two guide rails 55, 56, which extend in the left-right direction 9, are positioned in the printer 2. Both ends of the guide rails 55, 56 are fixed in the printer 2 respectively. The positions of the guide rails 55, 56 in the up-down direction 7 are identical with each other. The carriage 52 is placed on the guide rails 55, 56 so that the carriage 52 is movable in the left-right direction 9. The head 61 is carried on the carriage 52. The lower surface of the head 61 is referred to as “nozzle surface 64” (see FIGS. 9A, 9B, 9C). The head 61 has a plurality of nozzles 65 which is open on the nozzle surface 64. The nozzle surface 64 is an example of a first surface.

The conveying unit 51 includes a plurality of rollers, and the conveying unit 51 conveys the sheet 5 in the orientation (for example, frontwardly) along the front-rear direction 8. The area R depicted in FIG. 7 is the area through which the sheet 5 conveyed by the conveying unit 51 passes in the left-right direction 9. The flashing receiving unit 53 is positioned on the left of the area R in the left-right direction 9. The flashing receiving unit 53 has, for example, a sponge (not depicted) for absorbing the ink. The wiper 62 is a thin plate-shaped member made of rubber. The wiper 62 is positioned on the right of the area R in the left-right direction 9. The cap 54 is positioned on the right of the wiper 62 in the left-right direction 9. The flashing receiving unit 53, the wiper 62, and the cap 54 are positioned below the carriage 52 and the guide rails 55, 56 in the up-down direction 7. The carriage 52 is movable in the left-right direction 9 between the position at which the head 61 is positioned above the flashing receiving unit 53 (hereinafter referred to as “flashing position”) and the position at which the head 61 is positioned above the cap 54 (hereinafter referred to as “waiting position”).

The camera 63 is a camera which contains a microscope. The camera 63 is positioned in front of the guide rails 55, 56 at the position which is approximately the same as the position of the wiper 62 disposed at the fourth position (described later on) in the up-down direction 7 and the left-right direction 9. The camera 63 picks up the image of the wiper 62 and the vicinity of the wiper 62 from the position disposed in front of the guide rails 55, 56. When the wiper 62 is disposed at the fourth position, and the head 61 is moved in the left-right direction 9, then the camera 63 picks up the image of process of wiping up the ink 4 adhered to the nozzle surface 64 of the head 61 with the wiper 62 in the front-rear direction 8 (see FIG. 9C). The camera 63 is an example of a camera.

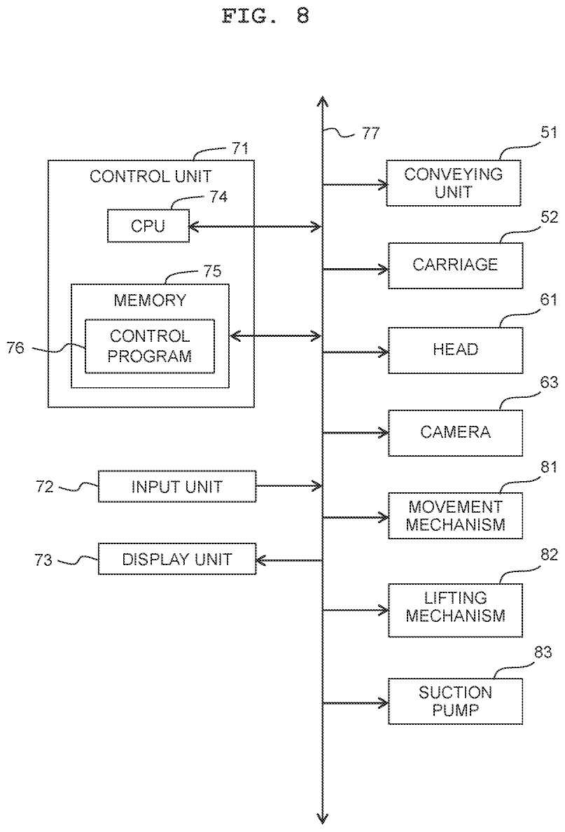

As depicted in FIG. 8, the printer 2 is provided with a control unit 71, an input unit 72, and a display unit 73. The input unit 72 is, for example, a touch panel. The display unit 73 is, for example, a liquid crystal display. The input unit 72 and the display unit 73 are positioned on the surface of the casing of the printer 2. The control unit 71 includes a CPU 74 and a memory 75. The memory 75 includes, for example, ROM, RAM, and the like. The memory 75 stores a control program 76. The CPU 74 and the memory 75 are positioned in the casing of the printer 2. The input unit 72, the display unit 73, the CPU 74, and the memory 75 are connected to a bus 77 in the printer 2. For example, the conveying unit 51, the carriage 52, the head 61, the camera 63, the movement mechanism 81, the lifting mechanism 82, and the suction pump 83 are also connected to the bus 77.

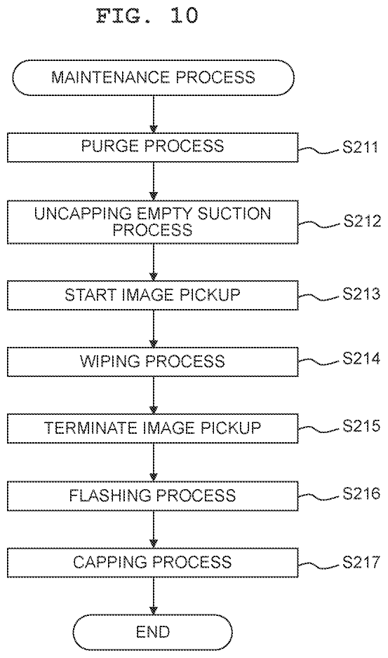

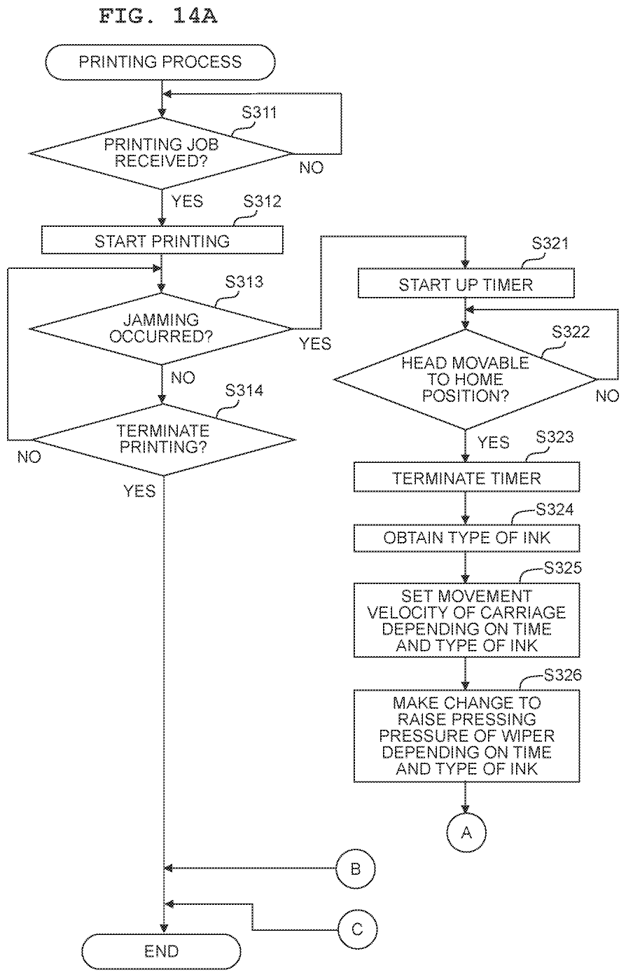

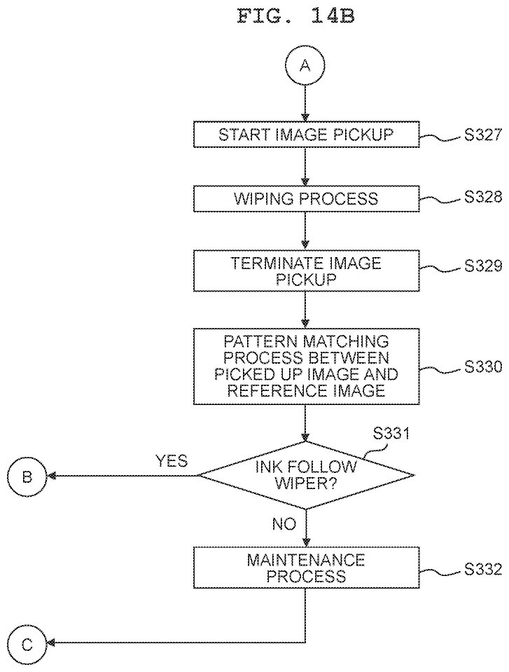

The CPU 74 executes a maintenance process (FIG. 10) and a printing process (FIG. 14) by executing the control program 76 stored in the memory 75. The CPU 74 and the memory 75 function as the control unit 71. The control unit 71 is an example of a controller. The control program 76 is an example of a program.

As depicted in FIGS. 9A, 9B, 9C, the movement mechanism 81 moves the cap 54 in the up-down direction 7 between the first position at which the cap 54 covers the head 61 and the second position at which the cap 54 covers the head 61. The position of the cap 54 depicted in FIG. 9B and FIG. 9C is the first position, and the position of the cap 54 depicted in FIG. 9A is the second position.

The lifting mechanism 82 moves the wiper 62 upward/downwardly between the third position (an example of a “lower position”) and the fourth position (an example of an “upper position”) which is higher than the third position. The position of the wiper 62 depicted in FIG. 9A and FIG. 9B is the third position, and the position of the wiper 62 depicted in FIG. 9C is the fourth position. The wiper 62, which is positioned at the fourth position, has the upper end which is positioned at a position near to the nozzle surface 64 of the head 61 in the up-down direction 7.

The cap 54 has a discharge port 57. The discharge port 57 is provided in order to discharge the ink or the like contained in the cap 54. One end (suction port) of the suction pump 83 is connected via a tube to the discharge port 57 of the cap 54. The other end (discharge port) of the suction pump 83 is connected via another tube to a waste liquid tank 58.

The printer 2 is provided with an undepicted ink storage unit (for example, an ink cartridge and an ink tank). The conveying unit 51 conveys the sheet 5 to a predetermined position in the front-rear direction 8 in accordance with the control performed by the control unit 71. The carriage 52 is moved in the left-right direction 9 in accordance with the control performed by the control unit 71. The ink, which is stored in the ink storage unit, is ejected from the nozzles 65 of the head 61 during the period in which the carriage 52 is moved. Accordingly, an image is recorded on the sheet 5 positioned under the head 61. Subsequently, the conveying unit 51 conveys the sheet 5 by a predetermined amount in the front-rear direction 8 in accordance with the control performed by the control unit 71. The printer 2 records the image on the sheet 5 by alternately performing the conveyance of the sheet 5 and the ejection of the ink.

### [Maintenance Process]

The control unit 71 executes the maintenance process depicted in FIG. 10 at a required timing. The control unit 71 executes the maintenance process, for example, in accordance with the reception of the instruction from the user via the input unit 72. In a state before the execution of the maintenance process, as depicted in FIG. 9A, the carriage 52 is positioned at the waiting position, the wiper 62 is positioned at the third position, and the cap 54 is positioned at the second position.

The control unit 71 executes the purge process at the beginning of the maintenance process (S211). The control unit 71 drives the suction pump 83 in the state in which the cap 54 covers the nozzle surface 64 of the head 61 (state depicted in FIG. 9A) in S211. Accordingly, the ink, the dust and the like, which are disposed in the vicinity of the nozzles 65 of the head 61, are sucked by the suction pump 83. The ink, the dust and the like, which are sucked by the suction pump 83, are stored in the waste liquid tank 58. The suction pump 83 is an example of a sucker (suction mechanism).

Subsequently, the control unit 71 executes the empty suction process in the uncapping state (S212). As depicted in FIG. 9B, the control unit 71 drives the movement mechanism 81 in S212 so that the cap 54 is moved downwardly from the second position to the first position to provide a state in which the cap 54 does not cover the nozzle surface 64 of the head 61. The control unit 71 drives the suction pump 83 in this state. After the control unit 41 executes S211 and S212, the ink 4 adheres to the nozzle surface 64 of the head 61 (see FIG. 9B). S212 is an example of a suction process.

Subsequently, the control unit 71 causes the camera 63 to start the image pickup (S213). The control unit 71 outputs an image pickup start signal to the camera 63 in S213. After receiving the image pickup start signal, the camera 63 picks up the image of the wiper 62 and the vicinity of the wiper 62. S213 is an example of a first image pickup starting process.

Subsequently, the control unit 71 executes the wiping process (S214). As depicted in FIG. 9C, the control unit 71 firstly drives the lifting mechanism 82 in S214 so that the wiper 32 is moved upwardly from the third position to the fourth position. Subsequently, the control unit 71 moves the carriage 52 to the position disposed on the left of the wiper 32. In this situation, the wiper 32 relatively moves with respect to the head 61 to wipe up the ink 4 adhered to the nozzle surface 64. Subsequently, the control unit 71 drives the lifting mechanism 82 so that the wiper 32 is moved downwardly from the fourth position to the third position.

Subsequently, the control unit 71 causes the camera 63 to terminate the image pickup (S215). The control unit 71 outputs an image pickup termination signal to the camera 63 in S215. The camera 63 terminates the image pickup for the wiper 62 and the vicinity of the wiper 62 in accordance with the reception of the image pickup termination signal. S215 is an example of the first image pickup terminating process. In this manner, the camera 63 picks up the image of the process of wiping up the ink 4 adhered to the nozzle surface 64 of the head 61 with the wiper 62 from the beginning to the end of the wiping process.

Subsequently, the control unit 71 executes the flashing process (S216). The control unit 71 further moves the carriage 52 leftwardly to the flashing position in S216, and ejects the ink forcibly from the nozzles 65 of the head 61 at the flashing position. The ink, which is ejected from the nozzles 65 of the head 61, is absorbed by the flashing receiving unit 53.

Subsequently, the control unit 71 executes the capping process (S217). The control unit 71 moves the carriage 52 to the initial position in S217, and drives the movement mechanism 81 to move the cap 54 upwardly from the first position to the second position. Accordingly, a state is given, in which the cap 54 covers the nozzle surface 64 of the head 61. Subsequently, the control unit 71 terminates the maintenance process.

Note that in the maintenance process depicted in FIG. 10, the control unit 71 causes the camera 63 to terminate the image pickup before the execution of the flashing process. In place thereof, the control unit 71 may cause the camera 63 to terminate the image pickup during the execution of the flashing process or after the execution of the flashing process.

### [Other Maintenance Processes]

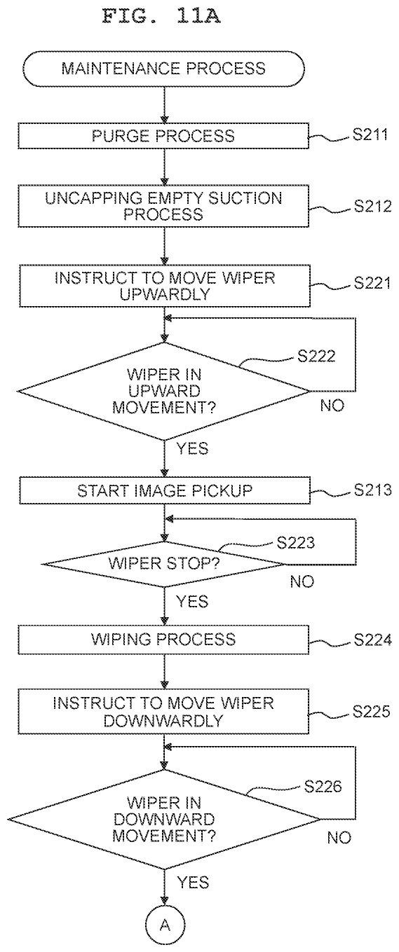

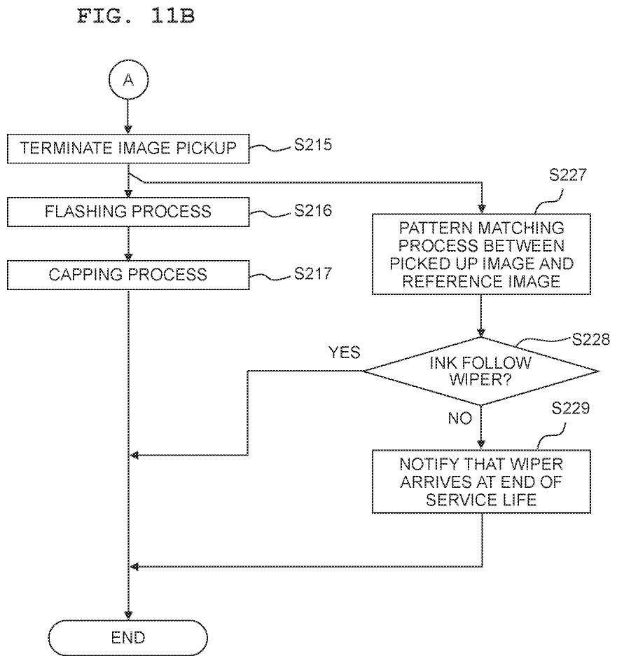

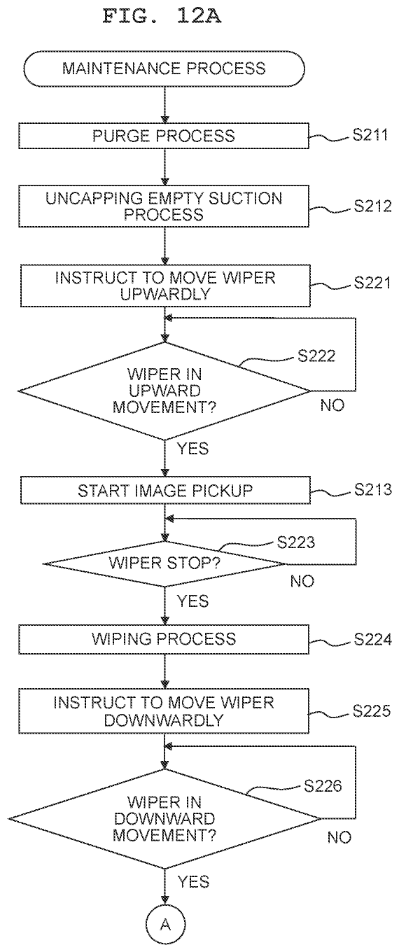

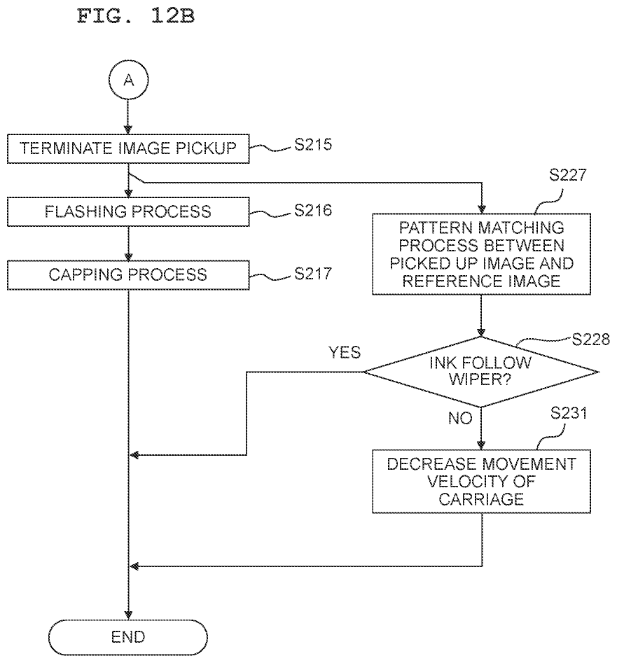

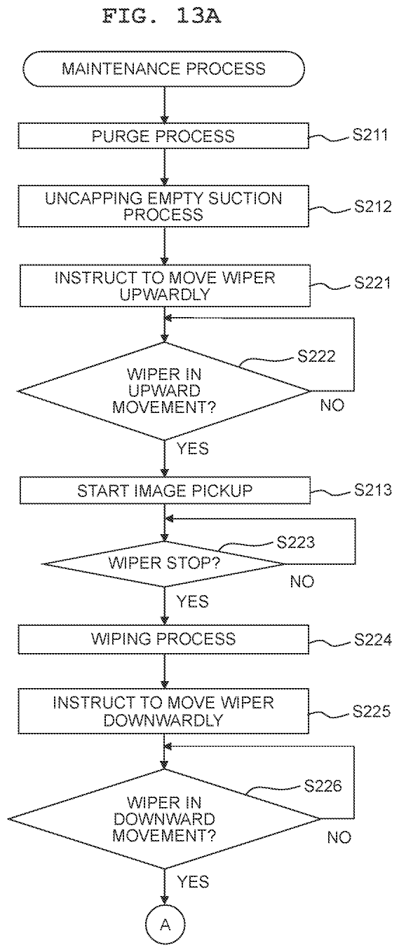

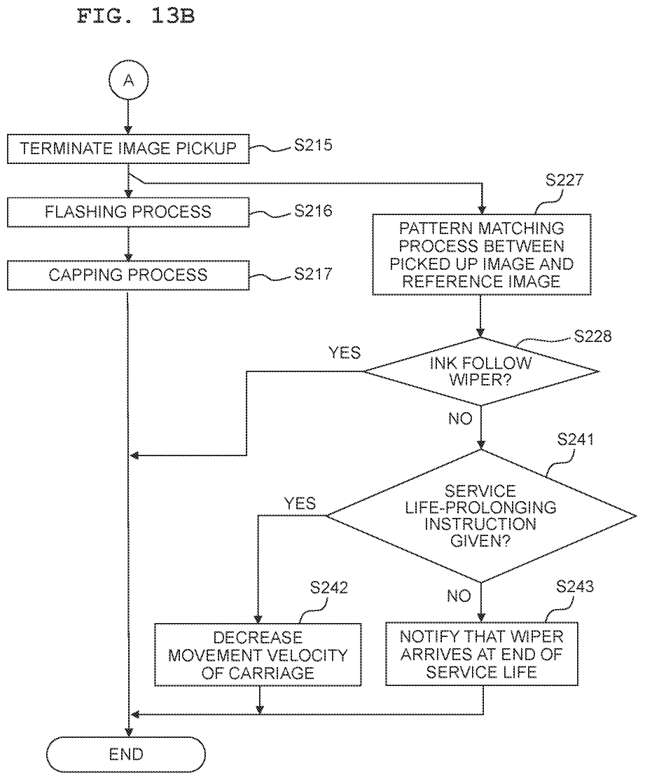

In place of the maintenance process depicted in FIG. 10, the control unit 71 may execute any one of maintenance process depicted in FIGS. 11A, 11B, maintenance process depicted in FIGS. 12A, 12B, and maintenance process depicted in FIGS. 13A, 13B. The maintenance process depicted in FIGS. 11A and 11B is obtained by modifying the maintenance process depicted in FIG. 10 such that S214 is replaced with S221, S224, and S225; and S222, S223 and S226 to S229 are added.

In the maintenance process depicted in FIGS. 11A and 11B, the control unit 71 instructs the lifting mechanism 82 to move the wiper 62 upwardly in S221 before executing the wiping process in S224. The control unit 71 waits in S222 until the wiper 62 moves upwardly after the execution of S221. The control unit 71 proceeds to S222 again in accordance with the determination that the wiper 62 has not started the upward movement yet in S222 (S222: No). The control unit 71 proceeds to S213 in accordance with the determination that the wiper 62 is in upward movement in S222 (S222: Yes). Subsequently, the control unit 71 causes the camera 63 to start the image pickup (S213). In this manner, the control unit 71 causes the camera 63 to start the image pickup during the period in which the lifting mechanism 82 moves the wiper 62 upwardly from the third position to the fourth position (that is at a timing during an upward movement of the wiper 62 by the lifting mechanism 82 from the third position to the fourth position). In this case, S213 is an example of a second image pickup starting process (image pickup starting process).

The control unit 71 waits in S223 until the wiper 62 stops after the execution of S213. The control unit 71 proceeds to S223 again in accordance with the determination that the wiper 62 has not stopped yet in S223 (S223: No). The control unit 71 proceeds to S224 in accordance with the determination that the wiper 62 has stopped in S223 (S223: Yes). The control unit 71 executes the wiping process in S224.

The control unit 71 instructs the lifting mechanism 82 to move the wiper 62 downwardly in S225 after the execution of the wiping process in S224. The control unit 71 waits in S226 until the wiper 62 moves downwardly after the execution of S225. The control unit 71 proceeds to S226 again in accordance with the determination that the wiper 62 has not started the downward movement yet in S226 (S226: No). The control unit 71 proceeds to S215 in accordance with the determination that the wiper 62 is in downward movement in S226 (S226: Yes). Subsequently, the control unit 71 causes the camera 63 to terminate the image pickup (S215). In this manner, the control unit 71 causes the camera 63 to terminate the image pickup during the period in which the lifting mechanism 82 moves the wiper 62 downwardly from the fourth position to the third position (that is at a timing during a downward movement of the wiper 62 by the lifting mechanism 82 from the fourth position to the third position). In this case, S215 is an example of a second image pickup terminating process (image pickup terminating process).

After the execution of S215, the control unit 71 executes S216 and S217, and executes S227 to S229 in parallel with the execution of S216 and S217. The control unit 71 executes the pattern matching process in S227 between the picked up image obtained by the camera 63 and the previously prepared reference image (S227). Subsequently, the control unit 71 determines whether or not the ink 4 follows the wiper 62 on the basis of the result of the pattern matching process in S227 (S228). S228 is an example of a first determining process.

The control unit 71 proceeds to S229 in accordance with the determination that the ink 4 does not follow the wiper 32 (S228: No). In this case, the control unit 71 notifies that the wiper 62 arrives at the end of the service life (S229). The control unit 71 causes, for example, the display unit 73 to display that the wiper 62 arrives at the end of the service life in S229. In place thereof, the control unit 71 may notify that the wiper 62 arrives at the end of the service life, for example, by making a sound from a speaker provided for the printer 2. The display unit 73 and the speaker are examples of a notifier (notifying unit). S229 is an example of a notifying process.

The control unit 71 terminates the maintenance process depicted in FIGS. 11A and 11B after the execution of S229. The control unit 71 terminates the maintenance process depicted in FIGS. 11A and 11B without executing S229 in accordance with the determination that the ink 4 follows the wiper 32 in S228 (S228: Yes).

The maintenance process depicted in FIGS. 12A and 12B is obtained by modifying the maintenance process depicted in FIGS. 11A and 11B such that S229 is replaced with S231. In the maintenance process depicted in FIGS. 12A and 12B, the control unit 71 proceeds to S231 in accordance with the determination that the ink 4 does not follow the wiper 62 in S228 (S228: No). In this case, the control unit 71 decreases the movement velocity of the carriage 52 (S231). When the movement velocity of the carriage 52 is decreased, the ink 4 is more likely to follow the wiper 62. The control unit 71 terminates the maintenance process depicted in FIGS. 12A and 12B after the execution of S231. S231 is an example of a second velocity decreasing process (velocity decreasing process).

The maintenance process depicted in FIGS. 13A and 13B is obtained by modifying the maintenance process depicted in FIGS. 11A and 11B such that S229 is replaced with S241 to S243. In the maintenance process depicted in FIGS. 13A and 13B, the control unit 71 proceeds to S241 in accordance with the determination that the ink 4 does not follow the wiper 62 in S228 (S228: No). In this case, the control unit 71 determines whether or not a service life-prolonging instruction is given (S241). The control unit 71 determines whether or not the service life-prolonging instruction is given depending on whether or not the service life-prolonging instruction has been already inputted by the user via the input unit 72 in S241.

The control unit 71 proceeds to S242 in accordance with the determination that the service life-prolonging instruction is given (S241: Yes). In this case, the control unit 71 decreases the movement velocity of the carriage 52 (S242). The control unit 71 proceeds to S243 in accordance with the determination that the service life-prolonging instruction is not given (S241: No). In this case, the control unit 71 notifies that the wiper 62 arrives at the end of the service life (S243). The control unit 71 terminates the maintenance process depicted in FIGS. 13A and 13B after the execution of S242 or S243.

### [Printing Process]

The control unit 71 executes the printing process depicted in FIG. 14 in accordance with the instruction given by the user. The control unit 71 waits in S311 until a printing job is received at the beginning of the printing process. More specifically, the control unit 71 determines whether or not the printing job is received on the basis of whether or not the execution of the printing job is instructed via the input unit 72 in S311. The control unit 71 executes S311 again in accordance with the determination that the printing job is not received (S311: No). The control unit 41 proceeds to S312 in accordance with the determination that the printing job is received in S311 (S311: Yes).

Subsequently, the control unit 71 starts the printing (S312). After the execution of S312, the control unit 71 causes the conveying unit 51 to convey the sheet 5 in the front-rear direction, the control unit 71 moves the carriage 52 in the left-right direction 9, and the control unit 71 causes the nozzles 65 of the head 61 to eject the ink from the nozzles 65.

Subsequently, the control unit 71 determines whether or not the jamming has occurred (S313). In S313, the control unit 71 detects whether or not the carriage 52 is moved in accordance with an output signal of a sensor (not depicted) for indicating the position of the carriage 52. The control unit 71 determines whether or not the jamming has occurred depending on the obtained result. The control unit 71 proceeds to S314 in accordance with the determination that the jamming has not occurred (S313: No).

In this case, the control unit 71 determines whether or not the printing is to be terminated (S314). The control unit 71 determines whether or not the printing is to be terminated, for example, depending on whether or not the printing data of the printing job remains in S314. The control unit 71 proceeds to S313 in accordance with the determination that the printing is not to be terminated (S314: No). In this case, the control unit 71 proceeds to S313 again to continue the printing started in S312. The control unit 71 terminates the printing process in accordance with the determination that the printing is to be terminated in S314 (S314: Yes).

The control unit 71 proceeds to S321 in accordance with the determination that the jamming has occurred in S313 (S313: Yes). In this case, the control unit 71 starts up the timer (S321). After the execution of S321, the control unit 71 waits in S322 until the head 61 is movable to the home position. More specifically, the control unit 71 determines in S322 whether or not the head 61 is movable to the home position. The control unit 71 proceeds to S322 again in accordance with the determination that the head 61 is not movable to the home position (S322: No). The control unit 71 proceeds to S323 in accordance with the determination that the head 61 is movable to the home position (S322: Yes).

Subsequently, the control unit 71 stops the timer started up in S321 (S323). Accordingly, the time, which was required until the head 61 is movable to the home position, is obtained. Subsequently, the control unit 71 obtains the type of the ink (S324). In S324, the control unit 71 causes the display unit 73 to display, for example, a message “Input type of ink”. The control unit 71 obtains the type of the ink inputted via the input unit 72.

Subsequently, the control unit 71 sets the movement velocity of the carriage 52 in accordance with the time obtained in S323 and the type of the ink obtained in S324. Subsequently, the control unit 71 causes the display unit 73 to perform indication urging the user to raise the pressing pressure of the wiper 62 in accordance with the measured time and the type of the ink (S326). The control unit 71 causes the display unit 73 to display, for example, a message “Make change to raise pressing pressure of wiper” in S326. When the user sees the message displayed on the display unit 73, the user makes the change to raise the pressing pressure of the wiper 62. The user makes, for example, the change to increase the support angle of the wiper 62 and/or the change to shorten the distance between the head 61 and the wiper 62.

Subsequently, the control unit 71 causes the camera 63 to start the image pickup (S327). After the control unit 71 executes S327, the camera 63 picks up the image of the wiper 62 and the vicinity of the wiper 62. Subsequently, the control unit 71 executes the wiping process (S328). In S328, the control unit 71 drives the lifting mechanism 82 to move the wiper 62 upwardly from the third position to the fourth position. The control unit 71 drives the carriage 52 for a predetermined time period to move the head 61 leftwardly from an initial position by a predetermined amount so that the ink 4 adhered to the nozzle surface 64 of the head 61 is wiped up with the wiper 62. After that, the control unit 71 drives the carriage 52 for a predetermined time period to move the head 61 rightwardly by a predetermined amount toward the initial position.

Subsequently, the control unit 71 causes the camera 63 to terminate the image pickup (S329). When the control unit 71 executes S329, the camera 63 terminate the image pickup for the wiper 62 and the vicinity of the wiper 62. In this manner, the camera 63 picks up the image of the process of wiping up the ink 4 adhered to the nozzle surface 64 with the wiper 62 from the beginning to the end of the wiping process.

Subsequently, the control unit 71 executes the pattern matching process between the picked up image obtained by the camera 63 and a previously prepared reference image (S330). The reference image is an image obtained by previously picking up the image of the situation in which the ink 4 follows the wiper 62 and is wiped up with the wiper 62.

Subsequently, the control unit 71 determines whether or not the ink 4 follows the wiper 62 on the basis of the result of the pattern matching process in S330 (S331). The control unit 71 determines that the ink 4 follows the wiper 62 in accordance with the matching between the two images in S331.

The control unit 71 proceeds to S331 in accordance with the determination that the ink 4 does not follow the wiper 62 (S331: No). In this case, the control unit 71 executes any one of the maintenance processes depicted in FIG. 10 to FIG. 13 (S332). Subsequently, the control unit 71 terminates the printing process. The control unit 71 terminates the printing process without executing S332 in accordance with the determination that the ink 4 follows the wiper 62 in S330 (S331: Yes).

### [Function and Effect]

The printer 2 (printing apparatus) according to this embodiment includes the head 61 which has the nozzle surface 64 (first surface) to be subjected to adhesion of the ink 4 and the nozzles 65 for ejecting the ink 4, the wiper 62 which is relatively movable with respect to the head 61 and which wipes up the ink 4 adhered to the nozzle surface 64, and the camera 63 (image pickup unit) which picks up the image of the process of wiping up the ink 4 adhered to the nozzle surface 64 with the wiper 62 from the beginning to the end of the wiping process.

Therefore, according to the printer 2, the process of wiping up the ink 4 adhered to the nozzle surface 64 of the head 61 with the wiper 62 is subjected to the image pickup from the beginning to the end of the wiping process, and thus the situation of the ink 4 during the wiping up can be known in detail on the basis of the image picked up by the camera 63.

Further, the printer 2 is provided with the control unit 71, the cap 54 which has the discharge port 57, the suction pump 83 (sucker, suction mechanism) which is connected to the discharge port 57, and the movement mechanism 81 (an example of a carriage) which moves the cap 54 between the first position at which the cap 54 does not cover the head 61 and the second position at which the cap 54 covers the head 61. The control unit 71 executes the empty suction process (S212) in which the cap 54 is moved to the first position and the suction pump 83 is driven. After that, the control unit 71 executes the wiping process (S214) in which the wiper 62 is moved relatively with respect to the head 61 and the ink 4 adhered to the nozzle surface 64 of the head 61 is wiped up with the wiper 62. The control unit 71 executes the first image pickup starting process (S213 in FIG. 10) in which the camera 63 is caused to start the image pickup, after executing the empty suction process. The process for wiping up the liquid with the wiper can be correctly subjected to the image pickup from the beginning by starting the image pickup after the empty suction process.

Further, the control unit 71 executes the flashing process (S216) in which the ink 4 is ejected from the nozzles 65 of the head 61 after executing the wiping process. The control unit 71 executes the first image pickup terminating process (S215 in FIG. 10) for causing the camera 63 to terminate the image pickup before the execution of the flashing process, during the execution of the flashing process, or after the execution of the flashing process. The image pickup is terminated before the execution of the flashing process, during the execution of the flashing process, or after the execution of the flashing process, and thus the image of the process of wiping up the ink 4 with the wiper 62 can be picked up until the end of the process.

Further, the printer 2 is provided with the lifting mechanism 82 which moves the wiper 62 upwardly/downwardly between the third position and the fourth position which is higher than the third position. The control unit 71 executes the second image pickup starting process (image pickup starting process) (S213 in FIGS. 11A, 12A, 13A) in which the camera 63 is caused to start the image pickup during the period in which the lifting mechanism 82 moves the wiper 62 upwardly from the third position to the fourth position. By starting the image pickup during the period in which the wiper 62 is moved upwardly, the image pickup can be started at the preferred timing, and the image pickup time can be shorted.

Further, the control unit 71 executes the second image pickup terminating process (image pickup terminating process) (S215 in FIGS. 11B, 12B, 13B) in which the camera 63 is caused to terminate the image pickup during the period in which the lifting mechanism 82 moves the wiper 62 downwardly from the fourth position to the third position. By terminating the image pickup during the period in which the wiper 62 is moved downwardly, the image pickup can be terminated at the preferred timing, and the image pickup time can be shorten.

Further, the printer 2 is provided with the display unit 73 (notifier, notifying unit). The control unit 71 executes the first determining process (S227) in which whether or not the ink 4 follows the wiper 62 is determined on the basis of the image picked up by the camera 63, and the notifying process (S228) in which the display unit 73 is caused to display that the wiper 62 arrives at the end of the service life in accordance with the determination that the ink 4 does not follow the wiper 62. Therefore, in a case where the ink 4 does not follow the wiper 62, the user can recognize that the wiper 62 arrives at the end of the service life.

Further, the printer 2 is provided with the carriage 52 which is movable while carrying the head 61. The control unit 71 executes the first determining process (S227) on the basis of the image picked up by the camera 63 and executes the second velocity decreasing process (velocity decreasing process) (S231) in which the movement velocity of the carriage 52 is decreased in accordance with the determination that the ink 4 does not follow the wiper 62. Therefore, in a case where the ink 4 does not follow the wiper 62, the wiping residue of the ink 4 can be decreased by decreasing the movement velocity of the carriage 52.

In the case of the observing apparatus 1 according to the first embodiment, the control unit 41 determines whether or not the ink 3 on the plate 31 is the latex-based ink, for example, on the basis of the input from the user at the beginning of the main process depicted in FIG. 3. The control unit 41 switches the execution of any one of the first observing process and the second observing process on the basis of the determination result. The method for switching the execution of any one of the first observing process and the second observing process in the observing apparatus is not limited thereto. In the case of observing apparatuses according to first and second modified embodiments of the first embodiment, the control unit 41 inquires of the user about the type of the ink 3 (specifically the model number of the ink). The control unit 41 switches the execution of any one of the first observing process and the second observing process in accordance with the type of the ink inputted by the user.

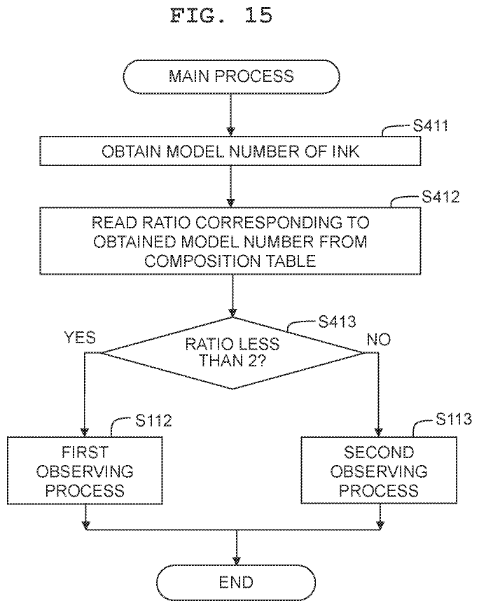

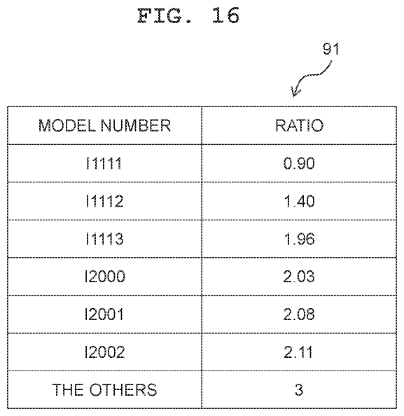

In the case of the observing apparatus according to the first modified embodiment of the first embodiment, the control unit 41 executes a main process depicted in FIG. 15. In the case of the observing apparatus according to the first modified embodiment, a composition table 91 depicted in FIG. 16 is stored in the memory 45. The composition table 91 stores the model number of the ink and the ratio of the resin fine particles contained in the ink of the concerning model number with respect to the solid content of the color material (hereinafter simply referred to as “ratio”), in a manner that the model number and the ratio correspond to one another. In the example depicted in FIG. 16, the ratio of the resin fine particles contained in the ink of the model number of 11113 with respect to the solid content of the color material is 1.96.

In the case of the observing apparatus according to the first modified embodiment, the control unit 41 obtains the model number of the ink 3 at the beginning of the main process depicted in FIG. 15 (S411). In S411, the control unit 41 causes the display unit 43 to display, for example, a message “Input model number of ink”, and the control unit 41 obtains the model number of the ink 3 inputted from the input unit 42.

Subsequently, the control unit 41 reads the ratio corresponding to the model number obtained in S411 from the composition table 91 stored in the memory 45 (S412). For example, when the control unit 41 obtains the model number I1113 in S411, the control unit 41 reads the ratio 1.96 from the composition table 91 in S412.

Subsequently, the control unit 41 determines whether or not the ratio read in S412 is less than 2 (S413). The control unit 41 proceeds to S112 in accordance with the determination that the ratio is less than 2 (S413: Yes), and the control unit 41 executes the first observing process depicted in FIG. 4 in S112. The control unit 41 proceeds to S113 in accordance with the determination that the ratio is not less than 2 (2 or more) in S413 (S413: No), and the control unit 41 executes the second observing process depicted in FIG. 5 in S113. Note that the first observing process and the second observing process are the same as those explained in the first embodiment. S412 is an example of a second determining process. The value 2 is an example of a predetermined amount. The control unit 41 may execute the first observing process depicted in FIG. 6 in S112.

The control unit 41 executes the first determining process (S126) to determine whether or not the ink 3 follows the wiper 32 on the basis of the image picked up by the camera 33 in the first observing process. The control unit 41 executes the first velocity decreasing process (S129) to decrease the relative velocity of the wiper 32 with respect to the plate 31 in accordance with the determination that the ink 3 does not follow the wiper 32 in the first determining process (S126: No). Further, the control unit 41 executes the first determining process (S126) in the second observing process. The control unit 41 executes the first velocity decreasing process (S129) and the urging indication process (S142) for causing the display unit 43 to perform indication urging the user to raise the pressing pressure of the wiper 32 in accordance with the determination that the ink 3 does not follow the wiper 32 in the first determining process (S126: No).

Both of the resin fine particles and the solid content of the color material are the materials which raise the viscosity of the ink. As described above, in the case of the ink used in the embodiment of the present disclosure, the content (R) of the resin fine particles with respect to the total amount of the ink is, for example, within a range of not less than 0.1 wt % and not more than 30 wt %. The content of the solid content of the color material with respect to the total amount of the ink is, for example, within a range of not less than 0.1 wt % and not more than 20.0 wt %. When the content (R) of the resin fine particles with respect to the total amount of the ink is within the range of not less than 0.1 wt % and not more than 30 wt %, and the content of the solid content of the color material with respect to the total amount of the ink is within the range of not less than 0.1 wt % and not more than 20.0 wt %, if the ratio (ratio of the resin fine particles with respect to the solid content of the color material) is not less than the predetermined amount (2 in this case), then the situation falls under the case in which the viscosity of the ink is high. Because of the reason as described above, the control unit 41 executes the first observing process in accordance with the determination that the ratio is less than 2 in S413, or the control unit 41 executes the second observing process in accordance with the determination that the ratio is not less than 2 in S413.

Note that in a case where the model number obtained in S411 is not included in the composition table 91, the control unit 41 executes the second observing process as described below in order to decrease the wiping residue. The composition table 91 depicted in FIG. 16 stores the model number of the ink “the others” and the ratio “3” in a manner that they correspond to one another. In a case where the model number obtained in S411 is not included in the composition table 91, the control unit 41 reads the ratio “3” corresponding to the model number of the ink “the others” from the composition table 91. Subsequently, the control unit 41 determines whether or not the ratio is less than 2 in S413. The control unit 41 determines that the ratio is not less than 2 in S413, and the control unit 41 executes the second observing process in S113.

As described above, in the case of the observing apparatus according to the first modified embodiment, the control unit 41 executes the second determining process (S412) of determining whether or not the ratio of the resin fine particles contained in the ink 3 with respect to the solid content of the color material is less than the predetermined amount, and the first determining process (S126) of determining whether or not the ink 3 follows the wiper 32 on the basis of the image picked up by the camera 33. The control unit 41 executes the first velocity decreasing process (S129) in accordance with the determination that the ratio is less than the predetermined amount in the second determining process and the determination that the ink 3 does not follow the wiper 32 in the first determining process, or the control unit 41 executes the first velocity decreasing process (S129) and the urging indication process (S142) in accordance with the determination that the ratio is not less than the predetermined amount in the second determining process and the determination that the ink 3 does not follow the wiper 32 in the first determining process. Therefore, in a case where the ink 3 does not follow the wiper 32, switching between the execution of the first velocity decreasing process and the execution of both of the first velocity decreasing process and the urging indication process (S142) can be performed, in accordance with the ratio of the resin fine particles contained in the ink 3 with respect to the solid content of the color material.

The observing apparatus 1 may execute the main process depicted in FIG. 3 immediately after the adhesion of the predetermined amount of the ink 3 to the upper surface 34 of the plate 31, or the observing apparatus 1 may execute the main process after the elapse of the predetermined waiting time after the adhesion of the ink 3. When the waiting time is provided as described above, the ink 3, which is adhered to the upper surface 34 of the plate 31, is dried. However, owing to the execution of the main process by the control unit 41 in the state in which the drying of the ink 3 advances, the movement velocity of the plate 31 and the pressing pressure of the wiper 32 with respect to the plate 31 is changed in the state in which the drying of the ink 3 advances, and thus the condition under which the ink 3 can be wiped up with the wiper 32 can be adjusted even in the state in which the drying of the ink 3 advances.

For example, when the jamming has occurred during the printing in the printer 2 according to the second embodiment, the head 61 cannot return to the position of the cap 54 in some cases depending on the position of the cap 54. Further, in such a situation, the ink is adhered to the nozzle surface 64 of the head 61 in some cases. In a case where the head 61 cannot return to the position of the cap 54, then the ink, which is adhered to the nozzle surface 64 of the head 61, is gradually dried as the time elapses, and wiping up of the ink with the wiper 32 becomes difficult. In view of the above, assuming that the jamming occurs during the printing, making the adjustment beforehand in order to adapt to various conditions is preferable so that the ink can be wiped up with the wiper 32 even in the state in which the drying of the ink advances. The observing apparatus according to the second modified embodiment of the first embodiment is provided in order to perform the adjustment as described above.

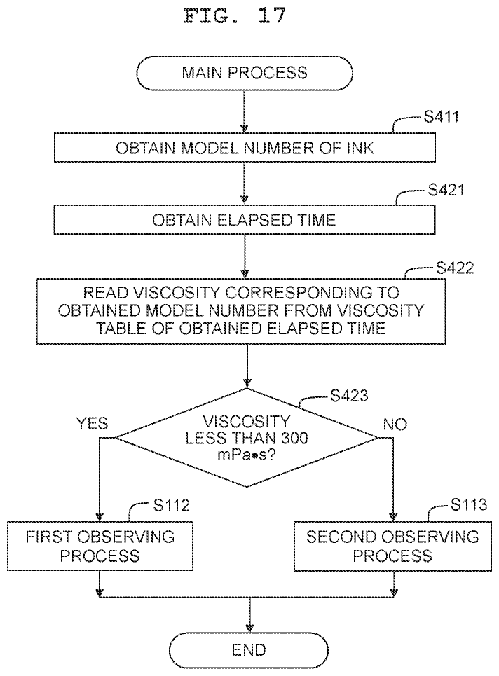

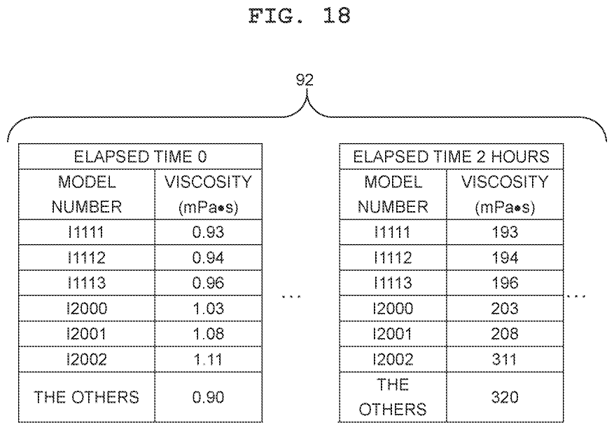

In the case of the observing apparatus according to the second modified embodiment of the first embodiment, the control unit 41 executes the main process depicted in FIG. 17. In the observing apparatus according to the second modified embodiment, viscosity tables 92 depicted in FIG. 18 are stored in the memory 45. The plurality of viscosity tables 92 are stored in the memory 45 depending on the elapsed time after the adhesion of the ink 3 to the upper surface 34 of the plate 31 (hereinafter simply referred to as “elapsed time”). The model number of the ink and the viscosity after the elapsed time of the ink of the concerning model number, which correspond to one another, are stored in each of the viscosity tables 92. The unit of the viscosity is mPa·s. In the example depicted in FIG. 18, the viscosity of the ink of the model number I2002, which is obtained after the elapse of 2 hours, is 311 mPa·s.

In the observing apparatus according to the second modified embodiment, the control unit 41 obtains the model number of the ink 3 at the beginning of the main process depicted in FIG. 17 (S411). In S411 depicted in FIG. 17, the control unit 41 executes the same process as that of S411 depicted in FIG. 15.

Subsequently, the control unit 41 obtains the elapsed time (elapsed time after the adhesion of the ink 3 to the upper surface 34 of the plate 34) (S421). The control unit 41 causes, in S421, the display unit 43 to display, for example, a message “Input elapsed time after adhesion of ink”. The control unit 41 obtains the elapsed time inputted from the input unit 42.

Subsequently, the control unit 41 reads the viscosity corresponding to the model number obtained in S411 from the viscosity table 92 corresponding to the elapsed time obtained in S421 (S422). In S422, the control unit 41 firstly selects one viscosity table 92 from the plurality of viscosity tables 92 stored in the memory 45 on the basis of the elapsed time obtained in S421. For example, if the elapsed time obtained in S421 is within 5 minutes, the control unit 41 selects the viscosity table 92 of the elapsed time 0. If the elapsed time obtained in S421 is not less than one and a half hours and within two and a half hours, the control unit 41 selects the viscosity table 92 of the elapsed time 2 hours. Subsequently, the control unit 41 reads the viscosity corresponding to the model number obtained in S411 from the selected viscosity table 92. For example, in a case where the model number 12002 is obtained in S411, and the elapsed time 1 hour 40 minutes is obtained in S421, then the control unit 41 reads the viscosity 311 mPa·s from the viscosity table 92 of the elapsed time 2 hours.

Subsequently, the control unit 41 determines whether or not the viscosity read in S422 is less than 300 mPa·s (S423). The control unit 41 proceeds to S112 in accordance with the determination that the viscosity is less than 300 mPa·s (S423: Yes). The control unit 41 executes the first observing process depicted in FIG. 4 in S112. The control unit 41 proceeds to S113 in accordance with the determination that the viscosity is not less than 300 mPa·s (300 mPa·s or more) (S423: No). The control unit 41 executes the second observing process depicted in FIG. 5 in S113. Note that the first observing process and the second observing process are the same as those explained in the first embodiment. The control unit 41 may execute the first observing process depicted in FIG. 6 in S112.

The number of the viscosity tables 92 stored in the memory 45 may be any number, provided that the number is 2 or more. The number of the viscosity tables 92 may be three, four, five, or six or more. Further, in the foregoing description, the plurality of viscosity tables 92 corresponding to the elapsed time are stored in the memory 45. However, the form of the viscosity table 92 is not limited thereto. The viscosity table 92 may be a matrix-shaped table in which the model number of the ink, the elapsed time, and the viscosity are stored in a manner that the model number of the ink, the elapsed time, and the viscosity correspond to one another.

### Modified Embodiments

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

A variety of modified embodiments can be configured in relation to the observing apparatus 1 and the printer 2 concerning the embodiments described above. For example, in an observing apparatus and a printer according to modified embodiments, the material of the wiper may be any material provided that the wiper can wipe up the ink. The type of the camera may be any type as well. In an observing apparatus according to a modified embodiment, the plate 31 may be moved by using any movement mechanism other than the electric cylinder 10. In an observing apparatus according to a modified embodiment, the pressing force of the wiper 32 with respect to the plate 31 may be changed by means of any method other than the three methods described above. In an observing apparatus according to a modified embodiment, the plate 31 may be fixed, and the wiper 32 and the camera 33 may be movable in the left-right direction 9 without changing the relative positional relationship.

In an observing apparatus and a printer according to modified embodiments, the image pickup direction of the camera is not limited to the direction which is orthogonal to the movement direction of the plate or the head. The image pickup direction of the camera may be any direction which intersects the movement direction of the plate or the head. In an observing apparatus and a printer according to modified embodiments, the control unit may start or terminate the image pickup at any timing other than the timing described above, provided that the process of wiping up the ink with the wiper can be subjected to the image pickup from the beginning to the end of the wiping process. In an observing apparatus and a printer according to modified embodiments, the control unit may determine whether or not the ink follows the wiper by means of any process other than the pattern matching process. A printer according to a modified embodiment may be provided with a rotating mechanism which rotates the wiper between the third position and the fourth position that is higher than the third position, in place of the lifting mechanism 82. A printing apparatus according to a modified embodiment may be a so-called multifunction machine which has, for example, the facsimile function and the scanner function in addition to the printing function.

In the first embodiment, the “beginning of wiping” may be at a time point when the wiper 32 touches the plate 31, may be at a time point when the wiper 32 touches the ink 3. In the first embodiment, the “end of wiping” may be at a time point when the wiper 32 detaches from the plate 31. The control unit 41 may start the image pickup at a same timing with the beginning of the wiping or at a timing before the beginning of the wiping. The control unit 41 may determine a timing when the image pickup is started and/or a timing when the image pickup is terminated, based on, for example, a distance in the left-right direction 9 from the initial position to the wiper 32, a moving velocity of the slider 14 and the like. Specifically, for example, the control unit 41 may start the image pickup after the setting of the moving velocity of the slider 14, and/or the control unit 41 may terminate the image pickup after passing of a predetermined time period after the starting of the image pickup.

In the second embodiment, the “beginning of wiping” may be at a time point when the wiper 62 touches the head 61. In the second embodiment, the “end of wiping” may be at a time point when the wiper 62 detaches from the head 61. Instead of or in addition to the timings described in the second embodiment, the control unit 71 may determine a timing when the image pickup is started and/or a timing when the image pickup is terminated, based on, for example, a distance in the left-right direction 9 from the waiting position to the wiper 62, a moving velocity of the carriage 52 and the like. Specifically, for example, the control unit 71 may start the image pickup after the start of the moving of the head 61 toward the wiper 62, and/or the control unit 71 may terminate the image pickup after passing of a predetermined time period after the starting of the image pickup.

What is claimed is:

1. An observing apparatus comprising:
a first member having a first surface;
a wiper configured to move relative to the first member and wipe up a liquid adhered to the first surface; and
a camera configured to pick up an image of a process of wiping up the liquid adhered to the first surface with the wiper from a beginning of the wiping up of the liquid to an end of the wiping up of the liquid.

2. The observing apparatus according to claim 1, wherein:
the wiper is configured to move relative to the first member in a first direction; and
the camera is configured to pick up the image of the process of wiping up the liquid with the wiper in a second direction intersecting the first direction and intersecting a facing direction, the wiper and the first member facing to each other in the facing direction.

3. The observing apparatus according to claim 2, wherein:
the wiper is fixed; and
the first member is configured to move in the first direction.

4. The observing apparatus according to claim 3, further comprising an electric cylinder including:
a stand configured to carry the first member placed on the stand; and
a motor configured to move the stand,
wherein the first member is configured to move in the first direction by the motor.

5. The observing apparatus according to claim 1, wherein the observing apparatus is configured to change a pressing pressure exerted on the first member by the wiper.

6. The observing apparatus according to claim 5, wherein the wiper is supported by a support member in a manner that a support angle of the wiper is changeable.

7. The observing apparatus according to claim 5, wherein the wiper is fixed at a predetermined position by a spring.

8. The observing apparatus according to claim 5, wherein:
the first surface has a water-repellent film; and
the observing apparatus is configured to change a distance between the water-repellent film and the wiper.

9. The observing apparatus according to claim 1 further comprising a controller, wherein the controller is configured to execute:
a first determining process of determining whether or not the liquid follows the wiper based on the image picked up by the camera; and
a first velocity decreasing process of decreasing a relative velocity of the wiper with respect to the first member in accordance with a determination that the liquid does not follow the wiper.

10. The observing apparatus according to claim 1 further comprising:
a controller; and
a display,
wherein the controller is configured to execute:
a first determining process of determining whether or not the liquid follows the wiper based on the image picked up by the camera; and
an urging indication process of causing the display to display a message, in accordance with a determination that the liquid does not follow the wiper.

11. The observing apparatus according to claim 10, wherein:
the wiper is supported by a support member in a manner that a support angle of the wiper is changeable; and
the controller is configured to execute the urging indication process, in accordance with the determination that the liquid does not follow the wiper.

12. The observing apparatus according to claim 10, wherein:
the wiper is fixed at a predetermined position by a spring; and
the controller is configured to execute the urging indication process, in accordance with the determination that the liquid does not follow the wiper.

13. The observing apparatus according to claim 10, wherein:
the first surface has a water-repellent film;
the observing apparatus is configured to change a distance between the water-repellent film and the wiper; and
the controller is configured to execute the urging indication process, in accordance with the determination that the liquid does not follow the wiper.

14. The observing apparatus according to claim 1, further comprising:
a controller; and
a display,
wherein the controller is configured to execute:
a first determining process of determining whether or not the liquid follows the wiper based on the image picked up by the camera; and
an adaptation indication process of causing the display to display a message, in accordance with a determination that the liquid follows the wiper.

15. The observing apparatus according to claim 1, wherein:
a water-repellent film is applied on the first surface; and
the water-repellent film and the wiper are in a non-contact state throughout the wiping process from the beginning of the wiping up of the liquid to the end of the wiping up of the liquid.

16. The observing apparatus according to claim 15, wherein a distance between the water-repellent film and the wiper is not less than 0.1 mm and not more than 1.0 mm.

17. The observing apparatus according to claim 1 further comprising:
a controller; and
a display; wherein:
the controller is configured to execute a high viscosity state process depending on a viscosity of the liquid; and
the controller is configured to execute, in the high viscosity state process, a first determining process of determining whether or not the liquid follows the wiper based on the image picked up by the camera; and
the controller is configured to execute, in accordance with a determination that the liquid does not follow the wiper:
a first velocity decreasing process of decreasing a relative velocity of the wiper with respect to the first member; and
an urging indication process of causing the display to display a message.

18. The observing apparatus according to claim 1 further comprising a controller, wherein:
the controller is configured to execute a first determining process of determining whether or not the liquid follows the wiper based on the image picked up by the camera; and
the controller is configured to execute, before the execution of the first determining process:
a pattern matching process between the image picked up by the camera and a reference image; and
a switching process of switching the reference image to be used in the pattern matching process depending on a viscosity of the liquid.

19. The observing apparatus according to claim 1 further comprising:
a controller; and
a display; wherein:
the liquid includes resin fine particles and a solid content of a color material;
the resin fine particles are included in the liquid within a range of not less than 0.1 wt % and not more than 30 wt %;
the solid content of the color material is included in the liquid within a range of not less than 0.1 wt % and not more than 20 wt %;
the controller is configured to execute:
a second determining process of determining whether or not a ratio of the resin fine particles with respect to the solid content of the color material is less than a predetermined amount; and
a first determining process of determining whether or not the liquid follows the wiper based on the image picked up by the camera; and
the controller is configured to execute a first velocity decreasing process of decreasing a relative velocity of the wiper with respect to the first member in accordance with a determination that the ratio is less than the predetermined amount in the second determining process and a determination that the liquid does not follow the wiper in the first determining process; or
the controller is configured to execute the first velocity decreasing process and an urging indication process of causing the display to display a message in accordance with a determination that the ratio is not less than the predetermined amount in the second determining process and the determination that the liquid does not follow the wiper in the first determining process.

20. A printing apparatus comprising:
a head having a first surface and a nozzle configured to eject a liquid;
a wiper configured to move relative to the head and wipe up the liquid adhered to the first surface; and
a camera configured to pick up an image of a process of wiping up the liquid adhered to the first surface with the wiper from a beginning of the wiping up of the liquid to an end of the wiping up of the liquid.

21. The printing apparatus according to claim 20, further comprising:
a controller;
a cap having a discharge port;
a sucker connected to the discharge port; and
a carriage configured to move the cap between a first position and a second position, the cap not covering the head at the first position and the cap covering the head at the second position, wherein:
the controller is configured to execute a suction process of driving the sucker after moving the cap to the first position,
the controller is configured to execute a wiping process of causing the wiper to wipe up the liquid adhered to the first surface of the head by moving the wiper relative to the head, after the execution of the suction process; and
the controller is configured to execute a first image pickup starting process of causing the camera to start the image pickup after the execution of the suction process.

22. The printing apparatus according to claim 21, wherein:
the controller is configured to execute a flashing process of ejecting the liquid from the nozzle of the head after the execution of the wiping process; and
the controller is configured to execute a first image pickup terminating process of causing the camera to terminate the image pickup at a timing before the execution of the flashing process, during the execution of the flashing process, or after the execution of the flashing process.

23. The printing apparatus according to claim 20, further comprising:
a controller; and
a lift configured to move the wiper between a lower position and an upper position higher than the lower position,
wherein the controller is configured to execute an image pickup starting process of causing the camera to start the image pickup at a timing during an upward movement of the wiper by the lift from the lower position to the upper position.

24. The printing apparatus according to claim 23, wherein the controller is configured to execute an image pickup terminating process of causing the camera to terminate the image pickup at a timing during a downward movement of the wiper by the lift from the upper position to the lower position.

25. The printing apparatus according to claim 20, further comprising:
a controller; and
a notifier,
wherein the controller is configured to execute:
a first determining process of determining whether or not the liquid follows the wiper based on the image picked up by the camera; and
a notifying process of causing the notifier to notify arrival at an end of service life of the wiper, in accordance with a determination that the liquid does not follow the wiper.

26. The printing apparatus according to claim 20, further comprising:
a controller; and
a carriage configured to move in a state that the head is mounted on the carriage,
wherein the controller is configured to execute:
a first determining process of determining whether or not the liquid follows the wiper based on the image picked up by the camera; and
a velocity decreasing process of decreasing a movement velocity of the carriage in accordance with a determination that the liquid does not follow the wiper.

27. An observing method using a first member having a first surface, a wiper, and a camera, the observing method comprising:
moving the wiper relative to the first member so as to wipe up the liquid adhered to the first surface with the wiper; and
picking up an image of a process of wiping up the liquid adhered to the first surface with the wiper from a beginning of the wiping up of the liquid to an end of the wiping up of the liquid by the camera.
